(19) United States
(12) Patent Application Publication
(10) Pub. No.: US 2026/0006371 A1
(43) Pub. Date: Jan. 1, 2026

(54) DEFORMABLE MEMBER AND ELECTRONIC DEVICE INCLUDING SAME

(71) Applicant: Samsung Electronics Co., Ltd., Suwon-si (KR)

(72) Inventors: Sol KIM, Suwon-si (KR); Sunghwan KO, Suwon-si (KR); Mihyang KIM, Suwon-si (KR); Jeock LEE, Suwon-si (KR); Joonrae CHO, Suwon-si (KR)

(21) Appl. No.: 19/317,790

(22) Filed: Sep. 3, 2025

Related U.S. Application Data
(63) Continuation of application No. PCT/KR2024/001104, filed on Jan. 24, 2024.

(30) Foreign Application Priority Data
Mar. 24, 2023 (KR) 10-2023-0038847
Apr. 11, 2023 (KR) 10-2023-0047758

(51) Int. Cl. H04R 1/10

(52) U.S. Cl. CPC H04R 1/1075; H04R 1/1016

(57) ABSTRACT

An electronic device is provided. The electronic device includes a housing having a hole communicating with the outside; a speaker disposed inside the housing; an acoustic channel formed inside the housing and configured to propagate sound that is transmitted through the hole; a heat-generating source configured to generate heat; and a deformable member disposed inside the acoustic channel, and formed to at least partially close the acoustic channel in response to heat received from the heat-generating source.

### CROSS-REFERENCE TO RELATED APPLICATION(S)

This application is a continuation application, claiming priority under 35 U.S.C. § 365(c), of an International application No. PCT/KR2024/001104, filed on Jan. 24, 2024, which is based on and claims the benefit of a Korean patent application number 10-2023-0038847, filed on Mar. 24, 2023, in the Korean Intellectual Property Office, and of a Korean patent application number 10-2023-0047758, filed on Apr. 11, 2023, the disclosure of each of which is incorporated by reference herein in its entirety.

### BACKGROUND

### 1. Field

The disclosure relates to an electronic device. More particularly, the electronic device relates to a deformable member and an electronic device including the same.

### 2. Description of Related Art

With the development of electronic technology, various types of wearable electronic devices are required to be downsized and equipped with various functions. To meet this demand, various electronic components are mounted on printed circuit boards (PCBs).

At least one component related to sound effects may be disposed on the printed circuit board of the wearable electronic device. The components related to sound effects may include, e.g., a speaker and a microphone, and these components may be disposed in various shapes and arrangements inside the housing of the wearable electronic device in response to the exterior design of the wearable electronic device that is designed in various ways.

The wearable electronic device in which the speaker and microphone are disposed may be, e.g., an earphone (or earset, headphone, headset), or a hearing aid. The wearable electronic device may be worn on a portion close to the user's ear, and may be manufactured in a compact size for this purpose.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a deformable member and an electronic device including the same.

Additional aspects will be set forth in part in the description which follows and, in part, will be apparent from the description, or may be learned by practice of the presented embodiments.

In accordance with an aspect of the disclosure, an electronic device is provided. The electronic device includes a housing having a hole communicating with the outside, a speaker disposed inside the housing, an acoustic channel formed inside the housing and configured to propagate sound that is transmitted through the hole, a heat-generating source configured to generate heat, and a deformable member disposed inside the acoustic channel, and formed to at least partially close the acoustic channel in response to heat received from the heat-generating source.

In accordance with another aspect of the disclosure, an electronic device is provided. The electronic device includes a housing having a hole communicating with the outside, a speaker disposed inside the housing, an acoustic channel formed inside the housing and configured to propagate sound that is transmitted through the hole, a first deformable member disposed inside the acoustic channel, and a second deformable member disposed inside the acoustic channel and spaced apart from the first deformable member in the extending direction of the acoustic channel. The acoustic channel includes an overlapping area where the first deformable member and the second deformable member face each other when the first deformable member and the second deformable member are deformed.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an audio module according to an embodiment of the disclosure;

FIG. 3A is a side view illustrating an electronic device according to an embodiment of the disclosure;

FIG. 3B is a top view illustrating an electronic device according to an embodiment of the disclosure;

FIG. 4A is a side view illustrating an electronic device except for a first housing according to an embodiment of the disclosure;

FIG. 4B is a top view illustrating an electronic device except for a first housing according to an embodiment of the disclosure;

FIG. 4C is a side view illustrating an electronic device except for a first housing according to an embodiment of the disclosure;

FIG. 4D is a cross-sectional view illustrating an electronic device except for a first housing illustrated in FIG. 4B, taken along line A-A′, according to an embodiment of the disclosure;

FIG. 5A conceptually illustrates a structure of an electronic device according to an embodiment of the disclosure;

FIG. 5B conceptually illustrates a structure of an electronic device according to an embodiment of the disclosure;

FIG. 5C conceptually illustrates a structure of an electronic device according to an embodiment of the disclosure;

FIG. 6 conceptually illustrates a connection relationship between electronic device components according to an embodiment of the disclosure;

FIG. 7 is a view illustrating an operation of a deformable member according to an embodiment of the disclosure;

FIG. 8A is a view illustrating an operation of a deformable member according to an embodiment of the disclosure;

FIG. 8B is a portion of a cross-sectional view illustrating an electronic device for describing an operation of a deformable member according to an embodiment of the disclosure;

FIG. 8C is a portion of a cross-sectional view illustrating an electronic device for describing an operation of a deformable member according to an embodiment of the disclosure;

FIG. 9A is a view illustrating an operation of a deformable member according to an embodiment of the disclosure;

FIG. 9B is a portion of a cross-sectional view illustrating an electronic device for describing an operation of a deformable member according to an embodiment of the disclosure;

FIG. 9C is a portion of a cross-sectional view illustrating an electronic device for describing an operation of a deformable member according to an embodiment of the disclosure; and

FIG. 10 is a control block diagram illustrating an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

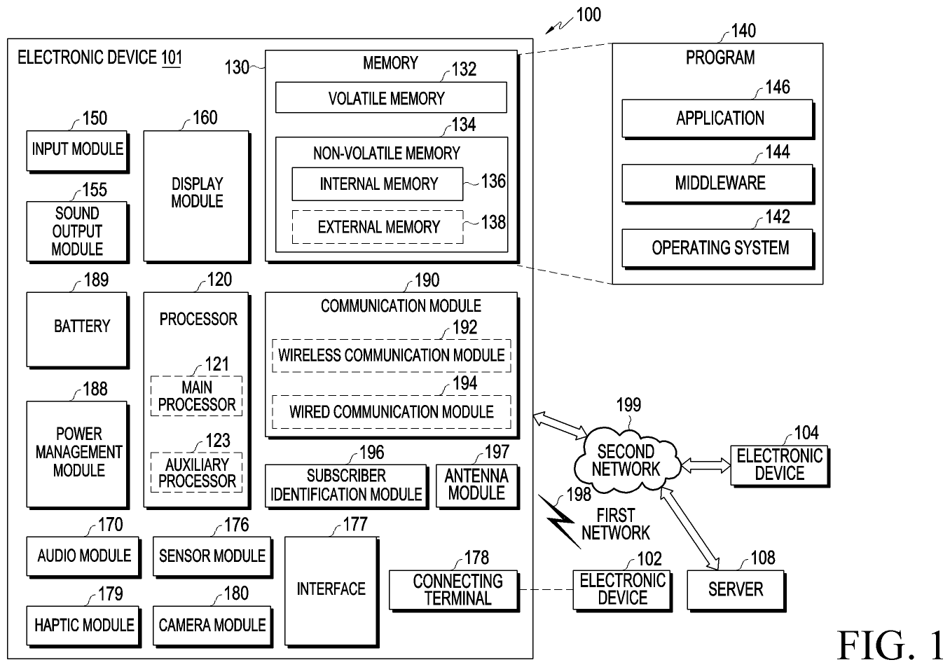

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 135 or external memory 138.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module may include an antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

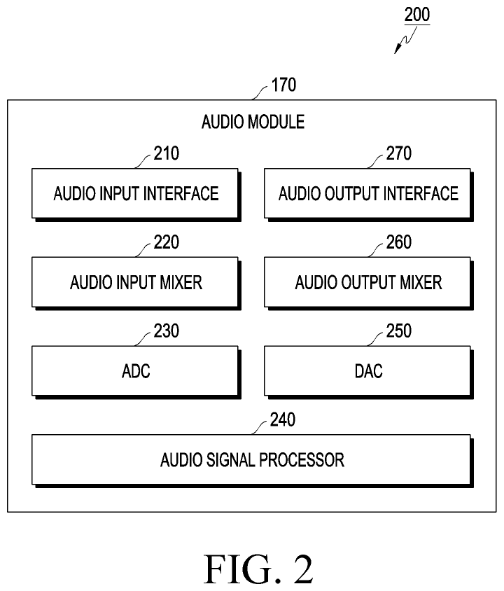

FIG. 2 is a block diagram 200 illustrating the audio module 170 according to an embodiment of the disclosure.

Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

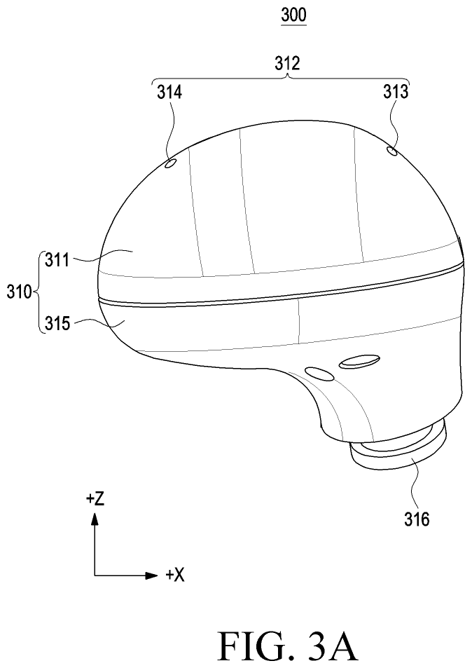

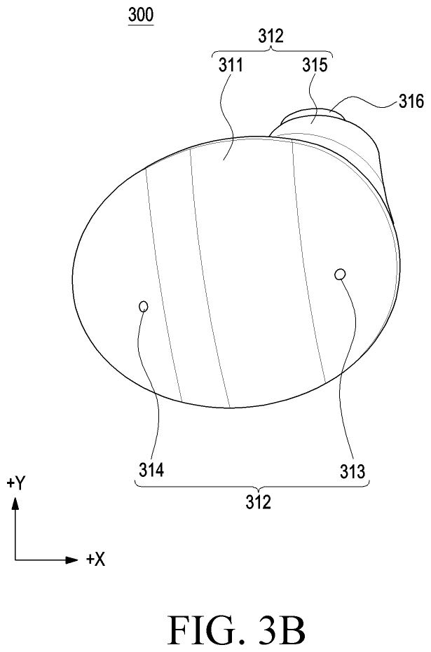

FIG. 3A is a side view illustrating an electronic device according to an embodiment of the disclosure, and FIG. 3B is a top view illustrating an electronic device according to an embodiment of the disclosure.

Referring to FIGS. 3A and 3B, the electronic device 300 (e.g., the electronic device 101 of FIG. 1) may include a housing 310 for receiving components of the electronic device 300. For example, sound components (e.g., the audio module 170 of FIG. 2) and electronic components (e.g., the processor 120, the power management module 188, the battery 189, or the wireless communication module 192 of FIG. 1) may be disposed inside the housing 310. The configuration of the electronic device 300 of FIGS. 3A and 3B may be substantially identical in whole or part to the configuration of the electronic device 101 of FIG. 1. Therefore, a description of the same configuration may be omitted.

According to various embodiments, the electronic device 300 may include a wearable electronic device. For example, the electronic device 300 may be worn on a portion of the user's body, e.g., ear or head. According to an embodiment, the electronic device 300 may include an in-ear earset, an in-ear headset, or a hearing aid.

According to various embodiments, as illustrated in FIGS. 3A and 3B, the electronic device 300 may have an asymmetric shape. According to an embodiment, by forming the electronic device 300 to have an asymmetric shape, the electronic device 300 is ergonomically designed, and user convenience may be increased. According to an embodiment, as the electronic device 300 is formed to have an asymmetric shape, sound components (e.g., the audio module 170 of FIG. 2) and electronic components (e.g., the processor 120 of FIG. 1) inside the housing 310 may be disposed to enhance sound performance.

According to various embodiments, the electronic device 300 may be wirelessly connected to communicate with an external electronic device (e.g., the electronic device 102 of FIG. 1) through the wireless communication module 192. According to an embodiment, the electronic device 300 may function as an audio output interface (or, e.g., the sound output module 155 of FIG. 1) that outputs a sound signal received from the external electronic device 102 to the outside.

Additionally or alternatively, the electronic device 300 disclosed in the disclosure may function as an audio input interface (or the input module 150 of FIG. 1) for receiving the audio signal corresponding to the sound obtained from the outside of the electronic device 300.

According to an embodiment, the electronic device 300 may communicate with and/or be controlled with the external electronic device 102. The electronic device 300 may be an interaction-type electronic device that is paired with the external electronic device 102 such as a smartphone through a communication scheme such as Bluetooth through the wireless communication module 192 to output sound by converting data received from the external electronic device 102 or to receive the user's voice and transmit it to the external electronic device 102.

According to an embodiment, the electronic device 300 may be wirelessly connected to the external electronic device 102. For example, the electronic device 300 may communicate with the external electronic device 102 via a network (e.g., a short-range wireless communication network or a long-range wireless communication network). The network is not limited thereto, but may include a mobile or cellular communication network, a local area network (LAN) (e.g., Bluetooth communication), a wireless local area network (WLAN), a wide area network (WAN), the Internet, or a small area network (SAN). According to an embodiment, the electronic device 300 may be wiredly connected to the external electronic device 102 using a cable (not shown).

According to an embodiment, the electronic device 300 may not communicate with the external electronic device 102. In this case, the electronic device 300 may be implemented not be controlled through the external electronic device 102, but to receive a signal corresponding to a sound obtained from the outside and output a sound signal to the outside according to the operation (or control) of the components included in the electronic device 300. For example, the electronic device 300 may be a stand-alone electronic device that plays music or a video stored in memory (e.g., the memory 130 of FIG. 1) by itself without communicating with the external electronic device 102 and outputs a sound or receives and processes the user's voice.

In various drawings of the disclosure, an in-ear earset of the kernel type, which is intended to be mounted in the external auditory canal leading from the auricle to the eardrum, may be primarily described as an example of the electronic device 300. However, it should be noted that the disclosure is not limited thereto. According to an embodiment, although not illustrated in the drawings, the electronic device 300 may be directed towards an open-type earset intended to be mounted on the auricle.

According to various embodiments, the housing 310 may include a plurality of components. For example, the housing 310 may include a first housing 311 and a second housing 315 connected to the first housing 311. According to an embodiment, the first housing 311 and the second housing 315 may form at least a portion of the exterior of the electronic device 300, and may form an inner space in which the components of the electronic device 300 are to be received. According to an embodiment, while the user wears the electronic device 300, at least a portion of the second housing 315 may contact or face the user's body (e.g., ear), and at least a portion of the first housing 311 may face in the opposite direction of the user.

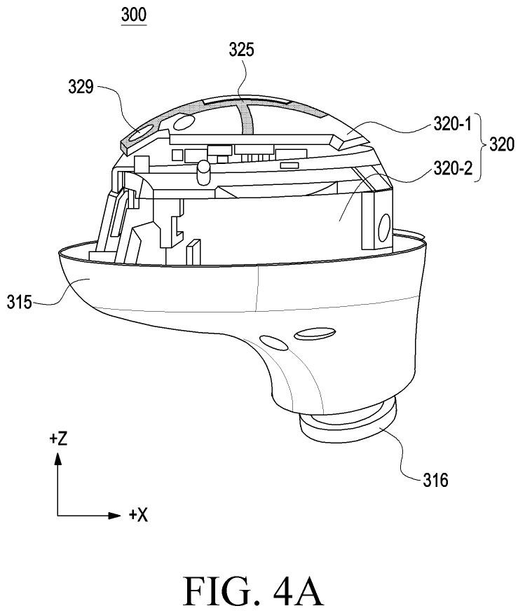

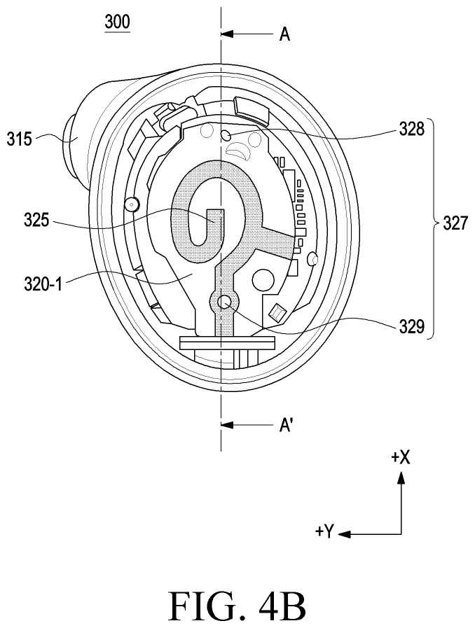

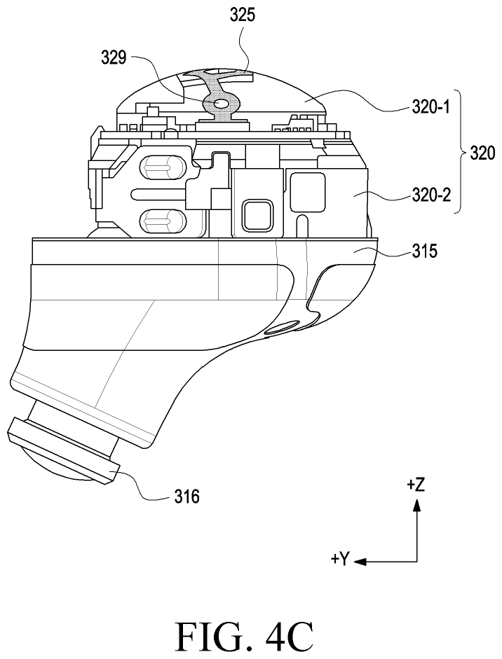

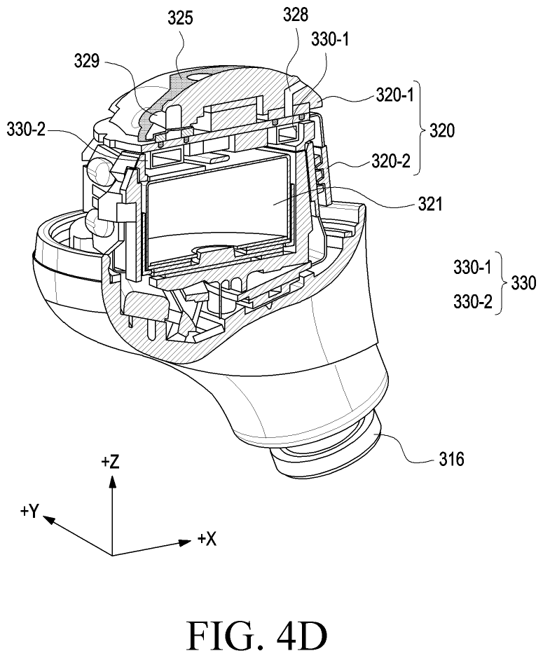

According to various embodiments, the housing 310 may include a microphone hole 312. According to an embodiment, the microphone hole 312 may be interpreted as a through hole formed in the first housing 311. According to an embodiment, the external sound of the electronic device 300 may pass through the microphone hole 312 and be transferred to a microphone module (e.g., the microphone module 330 of FIG. 4D) positioned inside the electronic device 300. According to an embodiment, the microphone hole 312 may include a plurality of microphone holes 313 and 314. The microphone hole 312 may include a first microphone hole 313 and/or a second microphone hole 314 spaced apart from the first microphone hole 313. According to an embodiment, the first microphone hole 313 may be disposed further adjacent to a protrusion 316 to be described below than the second microphone hole 314. According to an embodiment, the first microphone hole 313 may be formed to communicate with a first connection passage (e.g., the first connection passage 328 of FIG. 4B) to be described below, and the second microphone hole 314 may be formed to communicate with a second connection passage (e.g., the second connection passage 329 of FIG. 4B) to be described below.

According to various embodiments, the housing 310 may include a protrusion 316. According to an embodiment, at least a portion of the protrusion 316 may be inserted into the user's body (e.g., ear). For example, the electronic device 300 may be inserted and mounted on the user's body (e.g., the external ear canal or auricle of the body) using the protrusion 316. According to an embodiment, the protrusion 316 may be configured as a portion of the housing 310 extending from the second housing 315. According to an embodiment, an ear tip (not illustrated) may be additionally mounted on the protrusion 316, and the electronic device 300 may tightly contact the user's ear using the ear tip. According to an embodiment, the protrusion 316 includes at least one recess (not illustrated), and a sound output from a speaker module (e.g., the audio module 170 of FIG. 2) disposed inside the electronic device 300 may be radiated to the outside of the electronic device 300 using the recess positioned in the protrusion 316.

FIG. 4A is a side view illustrating an electronic device except for a first housing according to an embodiment of the disclosure, FIG. 4B is a top view illustrating an electronic device except for a first housing according to an embodiment of the disclosure, FIG. 4C is a side view illustrating an electronic device except for a first housing according to an embodiment of the disclosure, and FIG. 4D is a cross-sectional view illustrating an electronic device except for a first housing illustrated in FIG. 4B, taken along line A-A′, according to an embodiment of the disclosure.

Referring to FIGS. 4A, 4B, 4C, and 4D, an electronic device 300 may include a second housing 315 and a supporting member 320. The configuration of the electronic device 300 and the second housing 315 of FIGS. 4A, 4B, 4C, and 4D may be identical in whole or part to the configuration of the electronic device 300 and the second housing 315 of FIGS. 3A and 3B. Therefore, a description of the same configuration may be omitted.

According to various embodiments, the supporting member 320 may be disposed in a housing (e.g., the housing 310 of FIG. 3A). For example, at least a portion of the supporting member 320 may be surrounded by the housing 310 (e.g., the first housing 311 of FIG. 3A), and/or the second housing 315). According to an embodiment, the supporting member 320 may include a first supporting member 320-1 and a second supporting member 320-2.

According to various embodiments, the supporting member 320 may be utilized as an antenna carrier on which a conductive pattern 325 may be disposed. According to an embodiment, at least a portion (e.g., the first supporting member 320-1) of the supporting member 320 may be integrally formed with the first housing (e.g., the first housing 311 of FIG. 3A). The first supporting member 320-1 may be connected to the first housing 311 using insert injection molding or double shot injection molding. According to an embodiment, the first housing 311 may be coupled to the second housing 315 in a state of being connected to the first supporting member 320-1.

According to an embodiment, the battery 321 may be disposed inside the supporting member 320. The battery 321 may supply power necessary for driving the wearable electronic device 300.

According to an embodiment, the connection passage 327 may be formed or disposed in the first supporting member 320-1. The connection passage 327 is an empty space formed in the supporting member 320, and at least a portion of the connection passage 327 may serve as a microphone chamber. According to an embodiment, the supporting member 320 may include a second supporting member 320-2 (e.g., an inner housing) supporting at least a portion of the component (e.g., the battery 321) of the electronic device 300. According to an embodiment, the first supporting member 320-1 may be connected to the second supporting member 320-2. According to an embodiment, the first supporting member 320-1 may be integrally formed with the second supporting member 320-2.

According to various embodiments, a conductive pattern 325 may be disposed on the supporting member 320. According to an embodiment, a conductive pattern 325 may be disposed on the first supporting member 320-1. According to an embodiment, the conductive pattern 325 may entirely or partially have the same configuration as the antenna module 197 of FIG. 1. According to an embodiment, the conductive pattern 325 may be a laser direct structuring (LDS) antenna formed on the supporting member 320 (e.g., the first supporting member 320-1). For example, the supporting member 320 (e.g., the first supporting member 320-1) may include a pattern formed on thermoplastic resin using a thermoplastic resin (e.g., polycarbonate) and a laser. The conductive pattern 325 may include metal (e.g., copper (Cu) and/or nickel (Ni)) that is disposed or plated on the pattern formed on the supporting member 320 (e.g., the first support member 320-1).

According to various embodiments, the conductive pattern 325 may be disposed on the surface of the supporting member 320. According to an embodiment, the conductive pattern 325 may be disposed on the surface of the first supporting member 320-1. According to an embodiment, the conductive pattern 325 may be disposed to face the first housing (e.g., the first housing 311 of FIG. 3A). According to an embodiment, at least a portion of the conductive pattern 325 may be disposed between the first connection passage 328 corresponding to the position of the first microphone hole (e.g., the first microphone hole 313 of FIG. 3A) and the second connection passage 329 corresponding to the position of the second microphone hole (e.g., the second microphone hole 314 of FIG. 3A). According to an embodiment, the conductive pattern 325 may be disposed adjacent to the second connection passage 329. For example, the conductive pattern 325 may be disposed to at least partially surround the second connection passage 329. According to an embodiment, the conductive pattern 325 may be disposed to be spaced apart from the first connection passage 328.

According to various embodiments, the supporting member 320 may include a connection passage 327. According to an embodiment, the connection passage 327 may receive an external sound of the electronic device 300 from a microphone hole (e.g., the microphone hole 312 of FIG. 3A). For example, sound or vibration outside the electronic device 300 may be transferred to the microphone module 330 through the microphone hole 312 and the connection passage 327. The microphone module 330 may include a first microphone module 330-1 and a second microphone module 330-2. According to an embodiment, an external sound or vibration of the electronic device 300 may be transferred to the first microphone module 330-1 or the second microphone module 330-2. According to an embodiment, the connection passage 327 is an empty space formed in the supporting member 320 and may include a microphone path and/or a microphone chamber. For example, the connection passage 327 may form a microphone path to transfer external sound to the microphone module 330, and at least a portion of the microphone path may be formed of a microphone chamber including a space of a certain volume or larger.

According to various embodiments, the supporting member 320 may include a connection passage 327. According to an embodiment, the connection passage 327 may be connected to a microphone hole (e.g., the microphone hole 312 of FIG. 3A). According to an embodiment, the connection passage 327 may face at least a portion of the microphone hole 312. According to an embodiment, external sound of the electronic device 300 may be transferred to the microphone module 330 through the microphone hole 312 and the connection passage 327. According to an embodiment, the connection passage 327 may be interpreted as a structure spatially connected to the microphone hole 312.

According to an embodiment, the connection passage 327 may include at least one connection passage 328 and 329. For example, the connection passage 327 may include a first connection passage 328 facing at least a portion of the first microphone hole (e.g., the first microphone hole 313 of FIG. 3A) and/or a second connection passage 329 spaced apart from the first connection passage 328 and facing at least a portion of the second microphone hole (e.g., the second microphone hole 314 of FIG. 3A). The first connection passage 328 may extend toward the first microphone hole 313 and be interpreted as a first microphone chamber, and the second connection passage 329 may extend toward the second microphone hole 314 and be interpreted as a second microphone chamber.

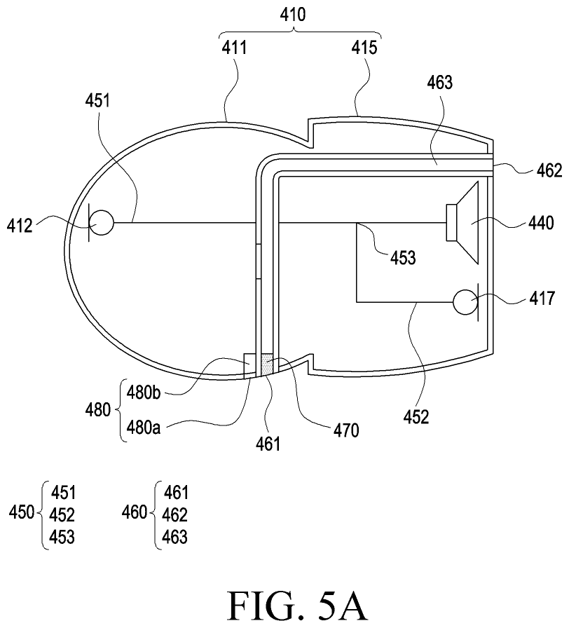

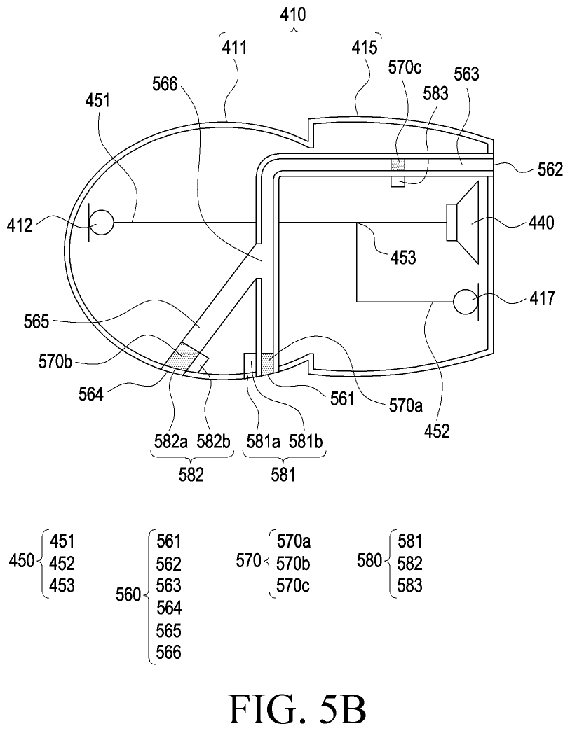

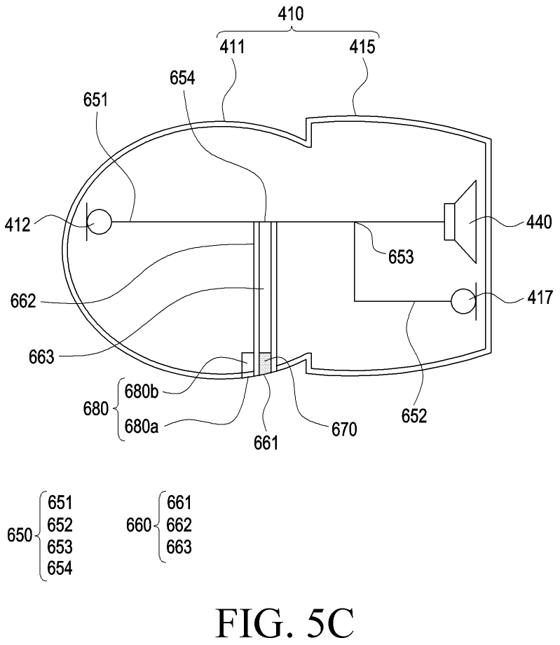

FIG. 5A conceptually illustrates an internal structure of an electronic device according to an embodiment of the disclosure.

Referring to FIG. 5A, the electronic device may include a deformable member 470. The configuration described with reference to FIG. 5A may be partially or entirely the same as the configuration described with reference to FIGS. 1, 2, 3A, 3B, and 4A to 4D.

According to an embodiment, the electronic device (e.g., 300 of FIG. 3A) may include a housing 410. The housing 410 may have a space therein. The external sound of the housing 410 may pass through the housing 410 and be transferred to the user's ear.

According to an embodiment, the housing 410 may include a first housing 411. The first housing 411 may form a portion of the housing 410.

According to an embodiment, the housing 410 may include a second housing 415. The second housing 415 may form a portion of the housing 410. The second housing 415 may be a portion inserted into the user's ear.

According to an embodiment, the first housing 411 may be coupled to the second housing 415. The first housing 411 and the second housing 415 may be integrally formed.

According to an embodiment, the electronic device (e.g., 300 of FIG. 3A) may include a speaker 440. A speaker 440 may output sound. The speaker 440 may be disposed inside the housing 410. The speaker 440 may transfer sound to the user's ear.

According to an embodiment, the housing 410 may include a first hole 412. The first hole 412 may be open to the outside of the housing 410. The external sound of the housing 410 may be transferred into the housing 410 through the first hole 412. The first hole 412 may be open in the first housing 411. The first hole 412 may be referred to as a hole.

According to an embodiment, the housing 410 may include a second hole 417. The second hole 417 may be open to the outside of the housing 410. The external sound of the housing 410 may be transferred into the housing 410 through the second hole 417. The second hole 417 may be open in the second housing 415. The second hole 417 may be referred to as a “hole.”

According to an embodiment, the sound generated from the outside of the housing 410 may be transferred into the housing 410 through the first hole 412. A portion of the sound reflected from the user's ears may be transferred into the housing 410 through the second hole 417.

According to an embodiment, the electronic device (e.g., 300 of FIG. 3A) may include a first acoustic channel 450. The first acoustic channel 450 may be formed inside the housing 410. The first acoustic channel 450 may be formed as a portion of the housing 410. The external sound of the housing 410 may be transferred through the first acoustic channel 450. The first acoustic channel 450 may be connected to the speaker 440. The sound transferred through the first acoustic channel 450 may be transferred to the speaker 440. The first acoustic channel 450 may be connected to the first hole 412. The external sound of the housing 410 may be transferred to the first acoustic channel 450 through the first hole 412. The first acoustic channel 450 may be connected to the second hole 417. The external sound of the housing 410 may be transferred to the first acoustic channel 450 through the second hole 417. The first acoustic channel 450 may be a sound path for transferring the external sound of the housing 410 to the speaker 440. The first acoustic channel 450 may be a sound path for transferring the external sound of the housing 410 to the user's ear.

According to an embodiment, the electronic device (e.g., 300 of FIG. 3A) may include a second acoustic channel 460. The second acoustic channel 460 may be formed inside the housing 410. The second acoustic channel 460 may be formed as a portion of the housing 410. The external sound of the housing 410 may be transferred through the second acoustic channel 460. The second acoustic channel 460 may be a sound path for transferring the external sound of the housing 410 to the user's ear. The second acoustic channel 460 may prevent or reduce an increase in pressure in the user's ear by flowing external air to the user's ear while the user's ear is sealed by the housing 410.

According to an embodiment, the electronic device (e.g., 300 of FIG. 3A) may include acoustic channels 450 and 460. The acoustic channels 450 and 460 may be formed inside the housing 410. The external sound of the housing 410 may be transferred through the acoustic channels 450 and 460. The acoustic channels 450 and 460 may include a first acoustic channel 450 and a second acoustic channel 460. The first acoustic channel 450 and the second acoustic channel 460 may be a kind of the acoustic channel. Except for cases in which the distinction between the first acoustic channel 450 and the second acoustic channel 460 is required, both the first acoustic channel 450 and the second acoustic channel 460 may be referred to as an “acoustic channel.”

According to an embodiment, the first acoustic channel 450 may include a main channel 451. The main channel 451 may extend from the first hole 412 toward the speaker 440. The main channel 451 may connect the first hole 412 to the speaker 440.

According to an embodiment, the first acoustic channel 450 may include a sub channel 452. The sub channel 452 may extend from the second hole 417 toward the main channel 451. The sub channel 452 may connect the second hole 417 to the main channel 451.

According to an embodiment, the first acoustic channel 450 may include a merging portion 453. The merging portion 453 may be a portion of the first acoustic channel 450 in which the main channel 451 and the sub channel 452 merge. The sound transferred to the sub channel 452 through the second hole 417 may be transferred to the main channel 451 through the merging portion 453.

According to an embodiment, the second acoustic channel 460 may include an inlet hole 461. The inlet hole 461 may be open to the outside of the housing 410. The external sound of the housing 410 may be transferred into the housing 410 through the inlet hole 461. The inlet hole 461 may be open in the first housing 411. The inlet hole 461 may be referred to as a “vent hole.” The inlet hole 461 may be referred to as a “hole.”

According to an embodiment, the second acoustic channel 460 may include an outlet hole 462. The outlet hole 462 may be open to the outside of the housing 410. The outlet hole 462 may be open in the second housing 415. The outlet hole 462 may be open toward the user's ear. The sound introduced into the inlet hole 461 may be transferred to the user's ear through the outlet hole 462.

According to an embodiment, the second acoustic channel 460 may include an acoustic path 463. The acoustic path 463 may connect the inlet hole 461 and the outlet hole 462. The sound introduced through the inlet hole 461 may be transferred to the outlet hole 462 through the acoustic path 463.

According to an embodiment, the electronic device (e.g., 300 of FIG. 3A) may include a deformable member 470. The deformable member 470 may be disposed in the acoustic channels 450 and 460. The deformable member 470 may be disposed in the first acoustic channel 450 or may be disposed in the second acoustic channel 460. The deformable member 470 may be disposed inside the acoustic channels 450 and 460, or may be disposed outside the acoustic channels 450 and 460.

According to an embodiment, the deformable member 470 may be disposed in the second acoustic channel 460. The deformable member 470 may be deformed inside the second acoustic channel 460. The deformable member 470 may be disposed in the inlet hole 461. The deformable member 470 may be disposed to face the outside of the housing 410.

According to an embodiment, the electronic device (e.g., 300 of FIG. 3A) may include a heat-generating source 480. The heat-generating source 480 may be disposed to be capable of heat exchange with the deformable member 470. The heat-generating source 480 may be disposed inside a wall surface of the housing 410 or in an inner space of the housing 410. For example, the heat-generating source 480 may include a first heat-generating source 480a disposed inside the wall surface of the housing 410 and a second heat-generating source 480b disposed in the inner space of the housing 410. However, the arrangement position of the heat-generating source 480 is not limited to thereto. The heat-generating source 480 may include only one of the first heat-generating source 480a and the second heat-generating source 480b. The heat-generating source 480 may be disposed inside or outside the second acoustic channel 460. For example, the heat-generating source 480 may be disposed inside the wall surface of the second acoustic channel 460, or may be disposed outside the wall surface of the second acoustic channel 460.

FIG. 5B conceptually illustrates an internal structure of an electronic device according to an embodiment of the disclosure.

Referring to FIG. 5B, the electronic device may include a deformable member 570. The configuration described with reference to FIG. 5B may be partially or entirely the same as the configuration described with reference to FIGS. 1, 2, 3A, 3B, and 4A to 4D. The configuration described with reference to FIG. 5B may be partially or entirely the same as the configuration described with reference to FIG. 5A.

According to an embodiment, the electronic device (e.g., 300 of FIG. 3A) may include a second acoustic channel 560. The second acoustic channel 560 may be formed inside the housing 410. The external sound of the housing 410 may be transferred through the second acoustic channel 560. The second acoustic channel 560 may be a sound path for transferring the external sound of the housing 410 to the user's ear. The second acoustic channel 560 may prevent or reduce an increase in pressure in the user's ear by flowing external air to the user's ear while the user's ear is sealed by the housing 410.

According to an embodiment, the electronic device (e.g., 300 of FIG. 3A) may include acoustic channels 450 and 560. The acoustic channels 450 and 560 may be formed inside the housing 410. The external sound of the housing 410 may be transferred through the acoustic channels 450 and 560. The acoustic channels 450 and 560 may include a first acoustic channel 450 and a second acoustic channel 560. The first acoustic channel 450 and the second acoustic channel 560 may be a kind of the acoustic channel. Except for cases in which the distinction between the first acoustic channel 450 and the second acoustic channel 560 is required, both the first acoustic channel 450 and the second acoustic channel 560 may be referred to as an “acoustic channel.”

According to an embodiment, the second acoustic channel 560 may include an inlet hole 561. The inlet hole 561 may be open to the outside of the housing 410. The external sound of the housing 410 may be transferred into the housing 410 through the inlet hole 561. The inlet hole 461 may be open in the first housing 411. The inlet hole 561 may be referred to as a “vent hole.” The inlet hole 561 may be referred to as a “first inlet hole.”

According to an embodiment, the second acoustic channel 560 may include an outlet hole 562. The outlet hole 562 may be open to the outside of the housing 410. The outlet hole 562 may be open in the second housing 415. The outlet hole 562 may be open toward the user's ear. The sound introduced into the inlet hole 561 may be transferred to the user's ear through the outlet hole 562.

According to an embodiment, the second acoustic channel 560 may include an acoustic path 563. The acoustic path 563 may connect the inlet hole 561 and the outlet hole 562. The sound introduced through the inlet hole 561 may be transferred to the outlet hole 562 through the acoustic path 563. The acoustic path 563 may be referred to as a “first acoustic path.”

According to an embodiment, the second acoustic channel 560 may include a second inlet hole 564. The second inlet hole 564 may be open in the housing 410. The second inlet hole 564 may be open in the first housing 411. The second inlet hole 564 may be spaced apart from the first inlet hole 561.

According to an embodiment, the second acoustic channel 560 may include a second acoustic path 565. The second acoustic path 565 may be connected to the second inlet hole 564. The external sound of the housing 410 may be transferred to the acoustic path 565 through the second inlet hole 564. The second acoustic path 565 may be connected to the first acoustic path 563.

According to an embodiment, the second acoustic channel 560 may include a path merging portion 566. The path merging portion 566 may be a portion of the second acoustic channel 560 in which the first acoustic path 563 and the second acoustic path 565 are merged. The sound flowing through the second acoustic path 565 may be transferred to the first acoustic path 563 through the path merging portion 566.

According to an embodiment, the electronic device (e.g., 300 of FIG. 3A) may include a deformable member 570. The deformable member 570 may be disposed in the acoustic channels 450 and 560. The deformable member 570 may be disposed in the first acoustic channel 450 or may be disposed in the second acoustic channel 560. The deformable member 570 may be disposed inside the acoustic channels 450 and 560, or may be disposed outside the acoustic channels 450 and 560.

According to an embodiment, the deformable member 570 may be disposed in the second acoustic channel 560. The deformable member 570 may be deformed inside the second acoustic channel 560.

According to an embodiment, a plurality of deformable members 570 may be disposed. The plurality of deformable members 570a, 570b, and 570c may be disposed in the second acoustic channel 560. Any one (e.g., 570a) of the plurality of deformable members 570a, 570b, and 570c may be disposed in the first inlet hole 561. Any one (e.g., 570a, 570b) of the plurality of deformable members (570a, 570b, 570c) may be disposed to face the outside of the housing 410. Any one (e.g., 570b) of the plurality of deformable members 570a, 570b, and 570c may be disposed in the second inlet hole 564. Any one (e.g., 570c) of the plurality of deformable members 570a, 570b, and 570c may be disposed inside the acoustic paths 563 and 565. The plurality of deformable members 570a, 570b, and 570c may be disposed inside the inlet holes 561 and 564 or the acoustic paths 563 and 565. However, the number and position of the deformable members 570a, 570b, and 570c are not limited to those described above. For example, only one deformable member 570a, 570b, or 570c may be disposed, or may be disposed at any one position inside the inlet holes 561 and 564 or the acoustic paths 563 and 565. The deformable member (e.g., 570a) disposed in the first inlet hole 561 may be referred to as a first deformable member 570a. The deformable member (e.g., 570b) disposed in the second inlet hole 564 may be referred to as a second deformable member 570b. The deformable member (e.g., 570c) disposed inside the acoustic paths 563 and 565 may be referred to as a third deformable member 570c.

According to an embodiment, the electronic device (e.g., 300 of FIG. 3A) may include a heat-generating source 580. The heat-generating source 580 may be disposed to be capable of heat exchange with the deformable member 570. The heat-generating source 580 may be disposed inside a wall surface of the housing 410 or in an inner space of the housing 410. For example, the heat-generating source 580 may include a first heat-generating source 581a, 582a disposed inside the wall surface of the housing 410 and a second heat-generating source 581b, 582b disposed in the inner space of the housing 410. However, the arrangement position of the heat-generating source 580 is not limited to thereto. The heat-generating source 580 may include only one of the first heat-generating source 581a, 582a and the second heat-generating source 581b, 582b. The first heat-generating source 581a, 582a may include a 1-1th heat-generating source 581a disposed to be capable of heat exchange with the first deformable member 570a and a 1-2th heat-generating source 582a disposed to be capable of heat exchange with the second deformable member 570b. The 1-1th heat-generating source 581a, the 1-2th heat-generating source 582a may be disposed inside a wall surface of the housing 410. The second heat-generating source 581b, 582b may include a 2-1th heat-generating source 581b disposed to be capable of heat exchange with the first deformable member 570a and a 2-2th heat-generating source 582b disposed to be capable of heat exchange with the second deformable member 570b. The 2-1th heat-generating source 581b and the 2-2th heat-generating source 582b may be disposed in the inner space of the housing 410. The heat-generating source 580 may include a first outer heat-generating source 581. The first outer heat-generating source 581 may be disposed to be capable of heat exchange with the first deformable member 570a. The first outer heat-generating source 581 may include a 1-1th heat-generating source 581a and a 2-1th heat-generating source 581b. The heat-generating source 580 may include a second outer heat-generating source 582. The second outer heat-generating source 582 may be disposed to be capable of heat exchange with the second deformable member 570b. The second outer heat-generating source 582 may include a 1-2th heat-generating source 582a and a 2-2th heat-generating source 582b. The heat-generating source 580 may include an inner heat-generating source 583 disposed to be capable of heat exchange with the third deformable member 570c. The inner heat-generating source 583 may be disposed in the inner space of the housing 410. The inner heat-generating source 583 may be coupled to a wall surface of the second acoustic channel 560. The heat-generating source 580 may be disposed inside or outside the second acoustic channel 560. For example, the heat-generating source 580 may be disposed inside the wall surface of the second acoustic channel 560, or may be disposed outside the wall surface of the second acoustic channel 560.

FIG. 5C conceptually illustrates an internal structure of an electronic device according to an embodiment of the disclosure.

Referring to FIG. 5C, the electronic device may include a deformable member 670. The configuration described with reference to FIG. 5C may be partially or entirely the same as the configuration described with reference to FIGS. 1, 2, 3A, 3B, and 4A to 4D. The configuration described with reference to FIG. 5C may be partially or entirely the same as the configuration described with reference to FIGS. 5A and 5B.

According to an embodiment, the electronic device (e.g., 300 of FIG. 3A) may include a first acoustic channel 650. The first acoustic channel 650 may be formed inside the housing 410. The external sound of the housing 410 may be transferred through the first acoustic channel 650. The first acoustic channel 650 may be connected to the speaker 440. The sound transferred through the first acoustic channel 650 may be transferred to the speaker 440. The first acoustic channel 650 may be connected to the first hole 412. The external sound of the housing 410 may be transferred to the first acoustic channel 650 through the first hole 412. The first acoustic channel 650 may be connected to the second hole 417. The external sound of the housing 410 may be transferred to the first acoustic channel 650 through the second hole 417. The first acoustic channel 650 may be a sound path for transferring the external sound of the housing 410 to the speaker 440. The first acoustic channel 650 may be a sound path for transferring the external sound of the housing 410 to the user's ear.

According to an embodiment, the electronic device (e.g., 300 of FIG. 3A) may include a second acoustic channel 660. The second acoustic channel 660 may be formed inside the housing 410. The external sound of the housing 410 may be transferred through the second acoustic channel 660. The second acoustic channel 660 may be a sound path for transferring the external sound of the housing 410 to the user's ear. The second acoustic channel 660 may prevent or reduce an increase in pressure in the user's ear by flowing external air to the user's ear while the user's ear is sealed by the housing 410.

According to an embodiment, the electronic device (e.g., 300 of FIG. 3A) may include acoustic channels 650 and 660. The acoustic channels 650 and 660 may be formed inside the housing 410. The external sound of the housing 410 may be transferred through the acoustic channels 650 and 660. The acoustic channels 650 and 660 may include a first acoustic channel 650 and a second acoustic channel 660. The first acoustic channel 650 and the second acoustic channel 660 may be a kind of the acoustic channel. Except for cases in which the distinction between the first acoustic channel 650 and the second acoustic channel 660 is required, both the first acoustic channel 650 and the second acoustic channel 660 may be referred to as an “acoustic channel.”

According to an embodiment, the first acoustic channel 650 may include a main channel 651. The main channel 651 may extend from the first hole 412 toward the speaker 440. The main channel 651 may connect the first hole 412 to the speaker 440.

According to an embodiment, the first acoustic channel 650 may include a sub channel 652. The sub channel 652 may extend from the second hole 417 toward the main channel 651. The sub channel 652 may connect the second hole 417 to the main channel 651.

According to an embodiment, the first acoustic channel 650 may include a first merging portion 653. The first merging portion 653 may be a portion of the first acoustic channel 650 in which the main channel 651 and the sub channel 652 merge. The sound transferred to the sub channel 652 through the second hole 417 may be transferred to the main channel 651 through the first merging portion 653.

According to an embodiment, the first acoustic channel 650 may include a second merging portion 654. The second merging portion 654 may be a portion of the first acoustic channel 650 in which the main channel 651 and the second acoustic channel 660 merge. The sound transferred to the second acoustic channel 660 through the inlet hole 661 may be transferred to the main channel 651 through the second merging portion 654.

According to an embodiment, the second acoustic channel 660 may be connected to the first acoustic channel 650. The second acoustic channel 660 may be connected to the main channel 651.

According to an embodiment, the second acoustic channel 660 may include an inlet hole 661. The inlet hole 661 may be open to the outside of the housing 410. The external sound of the housing 410 may be transferred into the housing 410 through the inlet hole 661. The inlet hole 661 may be open in the first housing 411. The inlet hole 661 may be referred to as a “vent hole.”

According to an embodiment, the second acoustic channel 660 may include an outlet hole 662. The sound introduced into the inlet hole 661 may be transferred to the outlet hole 662. The outlet hole 662 may be connected to the main channel 651.

According to an embodiment, the second acoustic channel 660 may include an acoustic path 663. The acoustic path 663 may connect the inlet hole 661 and the outlet hole 662. The sound introduced through the inlet hole 661 may be transferred to the outlet hole 662 through the acoustic path 663. The acoustic path 663 may be connected to the main channel 651. The external sound of the housing 410 introduced through the inlet hole 661 may be transferred to the main channel 651 through the acoustic path 663.

According to an embodiment, the electronic device (e.g., 300 of FIG. 3A) may include a deformable member 670. The deformable member 670 may be disposed in the acoustic channels 650 and 660. The deformable member 670 may be disposed in the first acoustic channel 650 or may be disposed in the second acoustic channel 660. The deformable member 670 may be disposed inside the acoustic channels 650 and 660, or may be disposed outside the acoustic channels 650 and 660.

According to an embodiment, the deformable member 670 may be disposed in the second acoustic channel 660. The deformable member 670 may be deformed inside the second acoustic channel 660. The deformable member 670 may be disposed in the inlet hole 661. The deformable member 670 may be disposed to face the outside of the housing 410.

According to an embodiment, the electronic device (e.g., 300 of FIG. 3A) may include a heat-generating source 680. The heat-generating source 680 may be disposed to be capable of heat exchange with the deformable member 670. The heat-generating source 680 may be disposed inside a wall surface of the housing 410 or in an inner space of the housing 410. For example, the heat-generating source 680 may include a first heat-generating source 680a disposed inside the wall surface of the housing 410 and a second heat-generating source 680b disposed in the inner space of the housing 410. However, the arrangement position of the heat-generating source 680 is not limited to thereto. The heat-generating source 680 may include only one of the first heat-generating source 680a and the second heat-generating source 680b. The heat-generating source 680 may be disposed inside or outside the second acoustic channel 660. For example, the heat-generating source 680 may be disposed inside the wall surface of the second acoustic channel 660, or may be disposed outside the wall surface of the second acoustic channel 660.

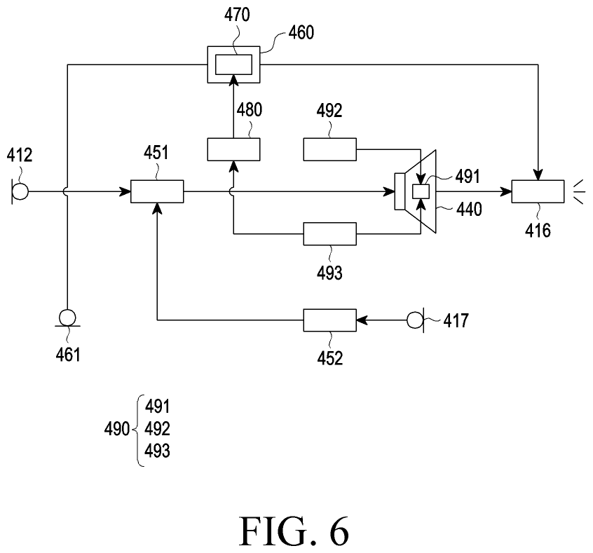

FIG. 6 conceptually illustrates a transmission path of sound or electrical signals of an electronic device (e.g., 300 of FIG. 3A) according to an embodiment of the disclosure.

The description of the components of FIG. 6 may be the same as some or all of the components described with reference to FIGS. 1, 2, 3A, 3B, 4A to 4D, and 5A to 5C.

According to an embodiment, the electronic device (e.g., 300 of FIG. 3A) may include a first hole 412, a second hole 417, a main channel 451, an sub channel 452, and a speaker 440. The main channel 451 may connect the first hole 412 and the speaker 440. The sound introduced into the first hole 412 may be transferred to the speaker 440 through the main channel 451. The sub channel 452 may connect the second hole 417 to the main channel 451. The sound introduced into the second hole 417 may be transferred to the main channel 451 through the sub channel 452. The electronic device (e.g., 300 of FIG. 3A) may include a protrusion 416. The protrusion 416 may protrude from the housing 410 (e.g., the housing 410 of FIGS. 5A to 5C). The protrusion 416 may be inserted into the user's ear. The main channel 451 may transfer sound to the speaker 440. The sound transferred to the speaker 440 may be transferred to the user's ear through the protrusion 416. The speaker 440 may output sound toward the protrusion 416.

According to an embodiment, the electronic device (e.g., 300 of FIG. 3A) may include an inlet hole 461 and an acoustic channel 460. The acoustic channel 460 may connect the inlet hole 461 to the protrusion 416. The sound introduced through the inlet hole 461 may be transferred to the protrusion 416 through the acoustic channel 460. However, the acoustic channel 460 may be connected to the speaker 440 instead of the protrusion 416.

According to an embodiment, the electronic device (e.g., 300 of FIG. 3A) may include a deformable member 470 and a heat-generating source 480. The deformable member 470 may be disposed inside the acoustic channel 460. The deformable member 470 may be deformed inside the acoustic channel 460. The heat-generating source 480 may supply heat to the deformable member 470. The heat-generating source 480 may be disposed to be capable of heat exchange with the deformable member 470. The heat-generating source 480 may be an electrical resistor. The deformable member 470 may be deformed in response to heat received from the heat-generating source 480. When heat supply from the heat-generating source 480 is stopped, the deformable member 470 may be deformed.

According to an embodiment, the electronic device (e.g., 300 of FIG. 3A) may include a processor 491. The processor 491 may be embedded in the speaker 440. The processor 491 may adjust the sound output from the speaker 440. The sound transferred through the main channel 451 may be manipulated by the processor 491 and transferred toward the protrusion 416.

According to an embodiment, the electronic device (e.g., 300 of FIG. 3A) may include a first controller 492. The first controller 492 may be electrically connected to the processor 491. The first controller 492 may transfer an electrical signal to the processor 491. The first controller 492 may sense the frequency band of the sound propagating in the main channel 451. The first controller 492 may transfer a signal related to the sound propagating in the main channel 451 to the processor 491. The processor 491 may generate a frequency in a band opposite to the frequency band of the sound propagating in the main channel 451 to cancel out the wave of sound introduced through the first hole 412. The first controller 492 may communicate with the outside of the housing 410 (e.g., the housing 410 of FIGS. 5A to 5C). The first controller 492 may receive a command signal for blocking the external sound of the housing 410 (e.g., the housing 410 of FIGS. 5A to 5C) from the outside of the housing 410. The command signal may be referred to as “active noise canceling (ANC).” The first controller 492 may be referred to as a “feedforward path controller.”

According to an embodiment, the electronic device (e.g., 300 of FIG. 3A) may include a second controller 493. The second controller 493 may be electrically connected to the processor 491. The second controller 493 may transfer an electrical signal to the processor 491. The second controller 493 may sense information (e.g., the frequency or the decibel of sound) reflected from the user's ear after being output through the protrusion 416. The second controller 493 may transfer the signal related to the sound reflected from the user's ear to the processor 491. The processor 491 may generate a frequency in a band opposite to the frequency band of the sound reflected from the user's ear to cancel out the wave of sound introduced through the second hole 417. The second controller 493 may communicate with the outside of the housing 410 (e.g., the housing 410 of FIGS. 5A to 5C). The second controller 493 may receive a command signal for blocking the external sound of the housing 410 (e.g., the housing 410 of FIGS. 5A to 5C) from the outside of the housing 410. The command signal may be referred to as “active noise canceling (ANC).” The second controller 493 may be referred to as a “feedback path controller.”

According to an embodiment, the heat-generating source 480 may be electrically connected to the first controller 492 or the second controller 493. The heat-generating source 480 may be electrically connected to at least one of the first controller 492 and the second controller 493, and for example, may be electrically connected to the second controller 493. The heat-generating source 480 may receive a command signal for blocking external sound from the controllers 492 and 493. The command signal may be referred to as “active noise canceling (ANC).” When receiving the command signal, the heat-generating source 480 may radiate heat to the deformable member 470.

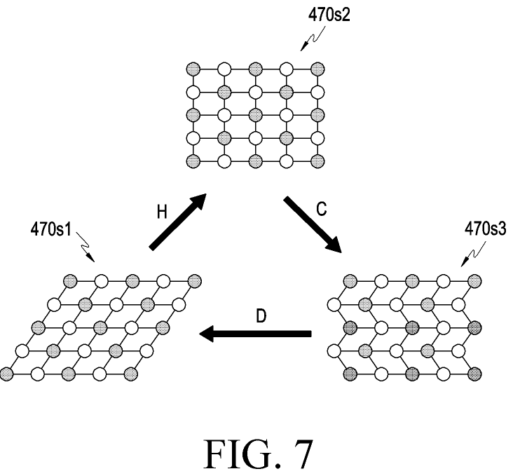

FIG. 7 is a view conceptually illustrating deformation of a deformable member (e.g., 470, 570, or 670 of FIGS. 5A to 5C) according to an embodiment of the disclosure.

The description of the component of FIG. 7 may be entirely or partially the same as the description of the components described with reference to FIGS. 1, 2, 3A, 3B, 4A to 4D, 5A to 5C, and 6.

According to an embodiment, the electronic device (e.g., 300 of FIG. 3A) may include a deformable member 470. The description of the component of FIG. 7 may be entirely or partially the same as the description of the components described with reference to FIGS. 1, 2, 3A, 3B, 4A to 4D, 5A to 5C, 6, 8A to 8C, 9A to 9C, and 10.

According to an embodiment, the deformable member 470 may be a shape memory alloy. The deformable member 470 may be heated or cooled to change its shape. The deformable member 470 may be a Ni—Ti-based shape memory alloy. The deformable member 470 may be a Cu—Al—Ni-based shape memory alloy. The deformable member 470 may be a Cu—Zn—Al-based shape memory alloy. The deformable member 470 may memorize its shape if left for a predetermined time (e.g., 30 minutes) within a specified temperature range (e.g., a range of 400 to 500 degrees Celsius) after being formed and remaining in a desired shape (e.g., 470s2 of FIG. 7). For example, the deformable member 470 may have a memorized shape (e.g., 470s2 of FIG. 7).

According to an embodiment, the deformable member 470 may be deformed into the memorized shape (e.g., 470s2 of FIG. 7) by receiving heat. The deformable member 470 may be heated (H) by the heat-generating source 480 (e.g., the heat-generating source 480 of FIG. 6) to be deformed into the memorized shape (e.g., 470s2 of FIG. 7). The deformable member 470 may be cooled (C) to be deformed. For example, the deformable member 470 may have a deformed shape (e.g., 470s1 and 470s3 of FIG. 7). The deformable member 470 may be deformed into the deformed shape (e.g., 470s1 and 470s3 of FIG. 7) by cooling (C) or deformation (D) by external force, and may be deformed into the memorized shape (e.g., 470s2 of FIG. 7) by heating (H).

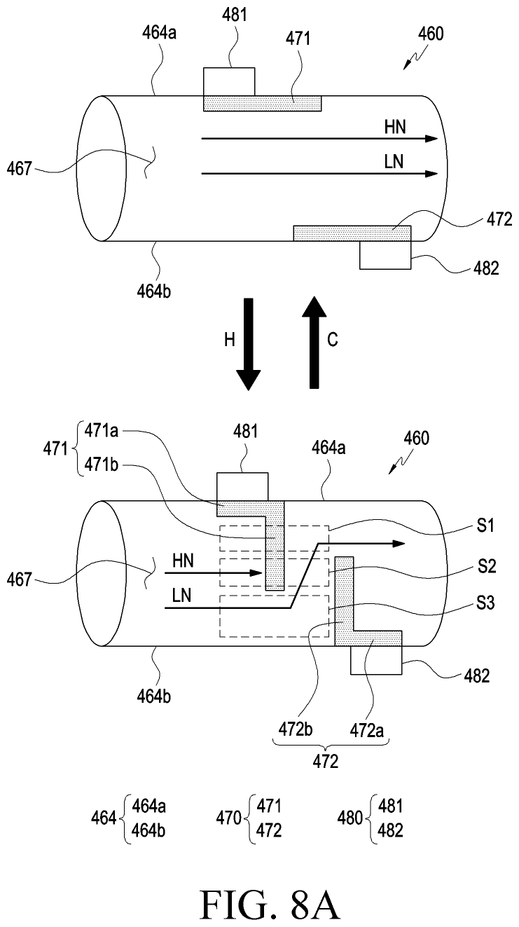

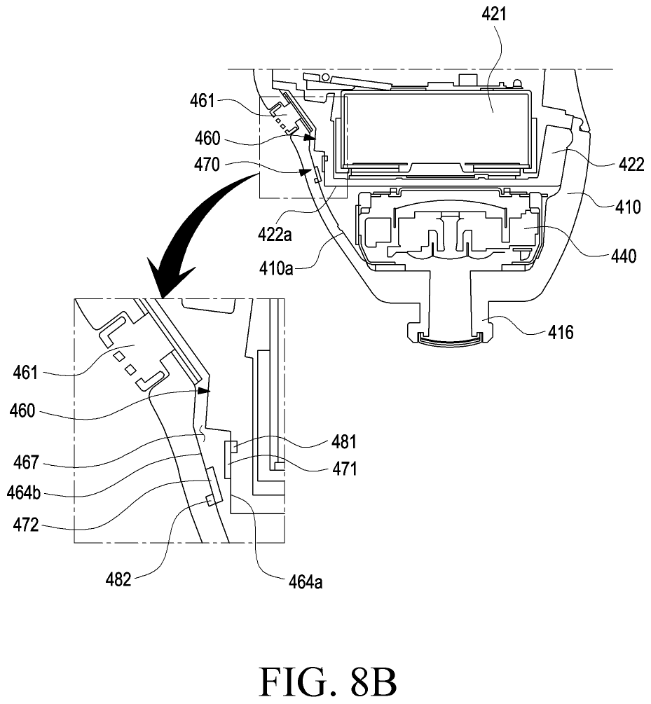

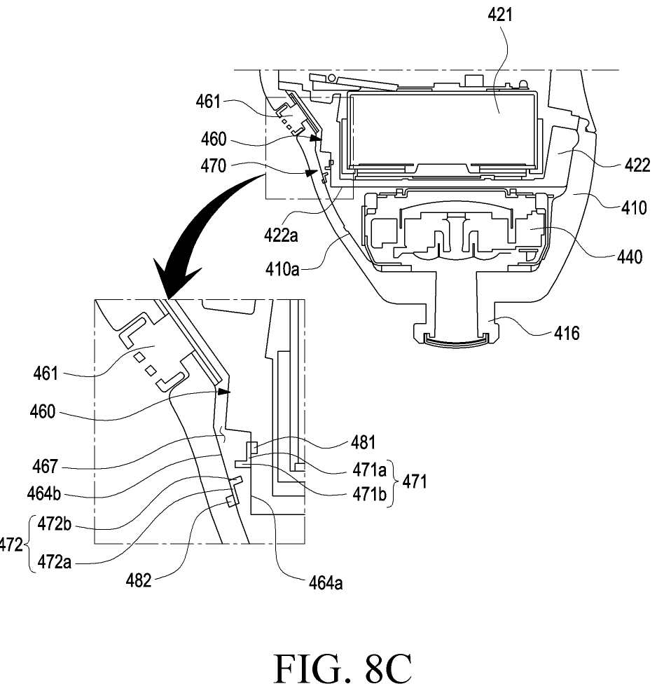

According to an embodiment, the deformable member 470 may have a shape recovery temperature. The shape recovery temperature may be a temperature condition for transforming the deformable member 470 into the memorized shape (e.g., 470s2 of FIG. 7). The deformable member 470 may have a plurality of shape recovery temperatures. The deformable member 470 may have a plurality of memorized shapes (e.g., 471a, 471b, 472a and 472b of FIG. 8A). For example, the deformable member 470 may be deformed into a first memory state (e.g., 471a and 471b of FIG. 8A) at a first temperature (e.g., 40 degrees Celsius) or higher, and may be deformed into a second memory state (e.g., 472a and 472b of FIG. 8A) at a second temperature (e.g., 50 degrees Celsius) or higher (e.g., the lower view of FIG. 8A).

According to an embodiment, at a temperature lower than the shape recovery temperature, the deformable member 470 may be deformed into the deformed shape (e.g., 471 and 472 of FIG. 8A). For example, at a temperature lower than the first temperature (e.g., 40 degrees Celsius), the deformable member 470 may be deformed into the deformed state (e.g., 471 and 472) (e.g., the upper view of FIG. 8A).

FIGS. 8A to 8C are views illustrating a deformation process of a deformable member 470 according to various embodiments of the disclosure. FIG. 8A conceptually illustrates deformation of a deformable member 470. FIG. 8B illustrates a state before a deformable member 470 is deformed into a memorized shape. FIG. 8C illustrates a state after a deformable member 470 is deformed into a memorized shape.

The description of the component of FIGS. 8A to 8C may be entirely or partially the same as the description of the components described with reference to FIGS. 1, 2, 3A, 3B, 4A to 4D, 5A to 5C, 6, and 7.

Referring to FIG. 8A, the deformable member 470 may be disposed inside the acoustic channel 460. The deformable member 470 may be deformably disposed inside the acoustic channel 460. The deformable member 470 may be deformed inside the acoustic channel 460 to close at least a portion of the acoustic channel 460.

According to an embodiment, the acoustic channel 460 may include an outer peripheral wall 464. The outer peripheral wall 464 may form an acoustic path 467 thereinside. The acoustic path 467 may mean a space in which sound is transferred. The deformable member 470 may be disposed in the acoustic path 467.

According to an embodiment, the outer peripheral wall 464 may include a first wall 464a. The outer peripheral wall 464 may include a second wall 464b. The first wall 464a and the second wall 464b may constitute a portion of the outer peripheral wall 464. The first wall 464a and the second wall 464b may be spaced apart from each other. The first wall 464a and the second wall 464b may be disposed to face each other.

According to an embodiment, the deformable member 470 may include a first deformable member 471. The deformable member 470 may include a second deformable member 472. The first deformable member 471 and the second deformable member 472 may be spaced apart from each other. The first deformable member 471 and the second deformable member 472 may be disposed on the inner surface of the outer peripheral wall 464. One of the first deformable member 471 and the second deformable member 472 may be disposed on the first wall 464a, and the other may be disposed on the second wall 464b.

According to an embodiment, the heat-generating source 480 may include a first heat-generating source 481. The heat-generating source 480 may include a second heat-generating source 482. The first heat-generating source 481 and the second heat-generating source 482 may be spaced apart from each other. The first heat-generating source 481 and the second heat-generating source 482 may be disposed on the outer surface of the outer peripheral wall 464. The first heat-generating source 481 may supply heat to the first deformable member 471. The first heat-generating source 481 may be disposed to be capable of heat exchange with the first deformable member 471. The second heat-generating source 482 may supply heat to the second deformable member 472. The second heat-generating source 482 may be disposed to be capable of heat exchange with the second deformable member 472.

According to an embodiment, the deformable member 470 may be deformed inside the acoustic path 467. The deformable member 470 may be deformed response to heat received from the heat-generating source 480. The heat-generating source 480 may heat (H) the deformable member 470 to deform the deformable member 470. The deformable member 470 may be deformed by cooling (C). The deformable member 470 may be deformed by cooling (C) when heat supply from the heat-generating source 480 is stopped.

According to an embodiment, the deformable member 470 may be deformed into a shape in which at least a portion is bent. The first deformable member 471 may include a first support portion 471a. The first support portion 471a may be disposed on the outer peripheral wall 464 of the acoustic channel 460. The first support portion 471a may be disposed to be capable of heat exchange with the first heat-generating source 481. The first deformable member 471 may include a first bent portion 471b. The first bent portion 471b may be bent from the first support portion 471a toward the center of the acoustic path 467. The first bent portion 471b may extend in a direction intersecting the first support portion 471a.

The term “bent” used in various embodiments may include bending. For example, “bent” may be used interchangeably with terms such as “curvature changed” and “bending at an angle.”

According to an embodiment, the deformable member 470 may be deformed into a shape in which at least a portion is bent. The second deformable member 472 may include a second support portion 472a. The second support portion 472a may be disposed on the outer peripheral wall 464 of the acoustic channel 460. The second support portion 472a may be disposed to be capable of heat exchange with the second heat-generating source 482. The second deformable member 472 may include a second bent portion 472b. The second bent portion 472b may be bent from the second support portion 472a toward the center of the acoustic path 467. The second bent portion 472b may extend in a direction intersecting the second support portion 472a.

According to an embodiment, the first support portion 471a may be disposed on the first wall 464a. The second support portion 472a may be disposed on the second wall 464b. The first bent portion 471b may extend from the first wall 464a toward the second wall 464b. The second bent portion 472b may extend from the second wall 464b toward the first wall 464a.

According to an embodiment, the first bent portion 471b may extend in a direction (e.g., a substantially orthogonal direction) intersecting the propagating direction of sound in the acoustic path 467. The second bent portion 472b may extend in a direction (e.g., a substantially orthogonal direction) intersecting the propagating direction of sound in the acoustic path 467. The first bent portion 471b and the second bent portion 472b may be spaced apart from each other along the propagating direction of the sound in the acoustic path 467. A portion of the first bent portion 471b and a portion of the second bent portion 472b may face each other in the propagating direction of the sound in the acoustic path 467.

According to an embodiment, when the deformable member 470 is heated (H) and at least partially bent, the acoustic channel 460 may have a first area S1. The first area S1 may mean an area in which the first bent portion 471b is positioned in the propagating direction of sound in the acoustic path 467.

According to an embodiment, when the deformable member 470 is heated (H) and at least partially bent, the acoustic channel 460 may have a second area S2. The second area S2 may mean an area in which the first bent portion 471b and the second bent portion 472b are positioned in the propagating direction of sound in the acoustic path 467. The second area S2 may be referred to as an “overlapping area.”

According to an embodiment, when the deformable member 470 is heated (H) and at least partially bent, the acoustic channel 460 may have a third area S3. The third area S3 may mean an area in which the second bent portion 472b is positioned in the acoustic path 467 in the propagating direction of the sound.

According to an embodiment, the external sound of the housing (e.g., the housing 410 of FIGS. 5A to 5C) may be transferred to the user's ear through the acoustic channel 460. The sound transferred through the acoustic channel 460 may include sound in a high frequency area HN and sound in a low frequency area LN. The sound in the high frequency area HN may have a stronger straightness than the sound in the low frequency area LN and, when there is an obstacle on the propagation path, the sound is not transferred. The sound in the low frequency area LN may have stronger diffraction than the sound in the high frequency area HN and, when there is an obstacle on the propagation path, the sound changes its propagation path and propagates.

According to an embodiment, due to the deformable member 470 according to an embodiment of the disclosure, the sound in the high frequency area HN may not be transferred in the acoustic path 467. For example, the sound in the high frequency area HN in the first area S1 may collide with the first bent portion 471b and may not be transferred. For example, the sound in the high frequency area HN in the second area S2 may collide with the first bent portion 471b and the second bent portion 472b and may not be transferred. For example, the sound in the high frequency area HN in the third area S3 may collide with the second bent portion 472b and may not be transferred.

Referring to FIG. 8B, the deformable member 470 may have a flat plate shape before being heated (e.g., the H process of FIG. 8A).

According to an embodiment, an electronic device (e.g., 300 of FIG. 3A) may include a housing 410, a battery 421, a speaker 440, and a protrusion 416. The description of the components 410, 421, 440, and 416 may be the same as the description of the components described with reference to FIGS. 1, 2, 3A, 3B, 4A to 4D, 5A to 5C, 6, and 7.

According to an embodiment, the electronic device (e.g., 300 of FIG. 3A) may include a battery supporter 422. The battery supporter 422 may provide a space in which the battery 421 is disposed. The battery supporter 422 may be spaced apart from the inner surface of the housing 410.

According to an embodiment, the acoustic channel 460 may be formed between the inner surface 410a of the housing 410 and the outer surface 422a of the battery supporter 422. The deformable member 470 may be disposed on each of the inner surface 410a of the housing 410 and the outer surface 422a of the battery supporter 422. The sound introduced into the housing 410 through the inlet hole 461 may be transferred to the protrusion 416 through the acoustic channel 460.

According to an embodiment, the acoustic path 467 may be formed between the housing 410 and the battery supporter 422. The outer surface 422a of the battery supporter 422 may form a first wall 464a of the acoustic channel 460. The inner surface 410a of the housing 410 may form a second wall 464b of the acoustic channel 460.

According to an embodiment, the first heat-generating source 481 and the second heat-generating source 482 may not heat the deformable members 471 and 472. The deformable members 471 and 472 may have a flat plate shape. The first deformable member 471 may be disposed to be flat along the outer surface 422a of the battery supporter 422. The second deformable member 472 may be disposed to be flat along the inner surface 410a of the housing 410. The deformable members 471 and 472 may not interfere with the sound transferred in the acoustic path 467.

Referring to FIG. 8C, the deformable member 470 may have a shape in which at least a portion of the deformable member 470 is bent after being heated (e.g., the H process of FIG. 8A).

According to an embodiment, the first heat-generating source 481 and the second heat-generating source 482 may heat (H) the deformable members 471 and 472. At least a portion of the deformable members 471 and 472 may be bent. The first support portion 471a may be disposed to be flat along the outer surface 422a of the battery supporter 422. The first bent portion 471b may extend toward the inner surface 410a of the housing 410. The second support portion 472a may be disposed to be flat along the inner surface 410a of the housing 410. The second bent portion 472b may extend toward the outer surface 422a of the battery supporter 422. The deformable members 471 and 472 may interfere with the sound transferred in the acoustic path 467. The first bent portion 471b and the second bent portion 472b may extend toward the center of the acoustic path 467 and may extend in a direction intersecting the propagating direction of the sound in the acoustic path 467. The first bent portion 471b and the second bent portion 472b may be spaced apart from each other in the extending direction of the acoustic path 467, and may close a portion of the acoustic path 467.

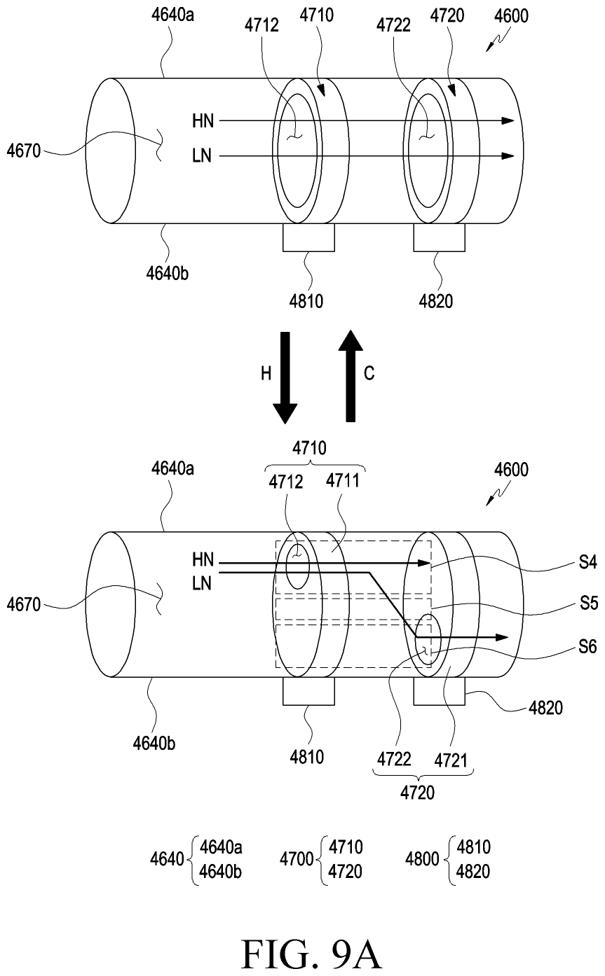

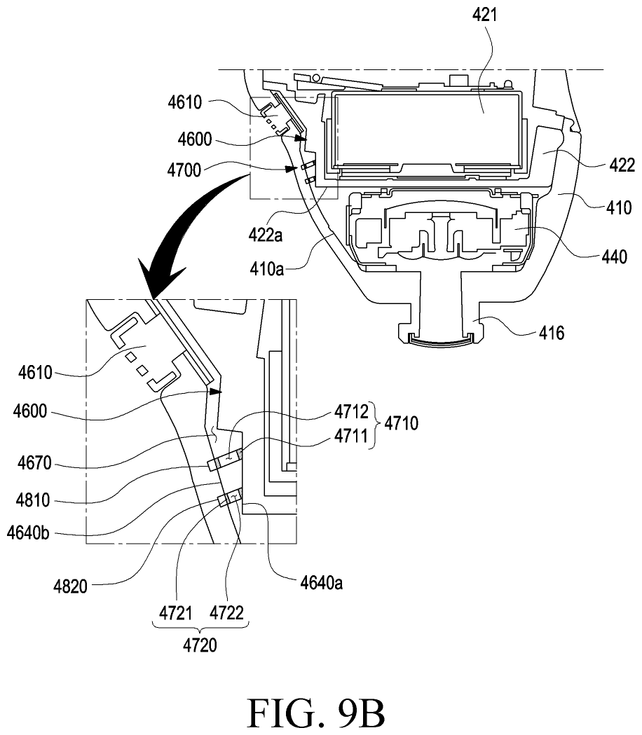

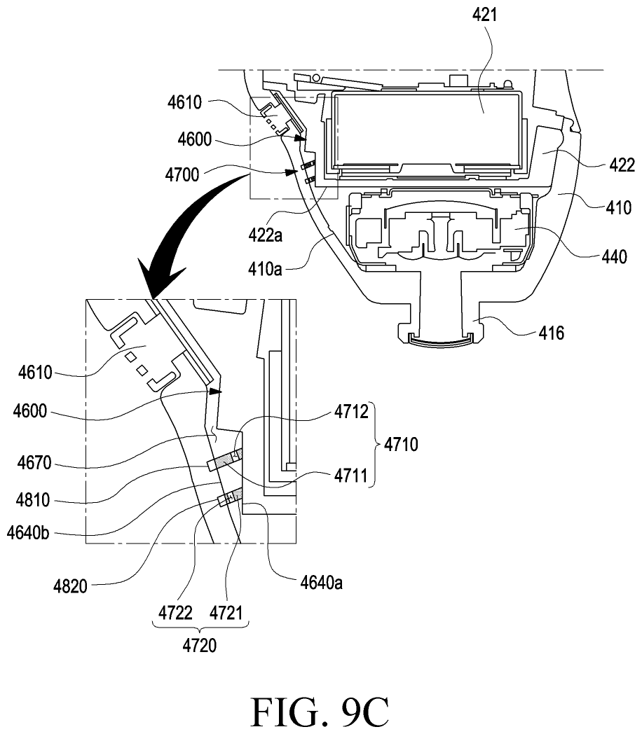

FIGS. 9A to 9C are views illustrating a deformation process of a deformable member 4700 according to various embodiments of the disclosure. FIG. 9A conceptually illustrates deformation of a deformable member 4700. FIG. 9B illustrates a state before a deformable member 4700 is deformed into a memorized shape. FIG. 9C illustrates a state after a deformable member 4700 is deformed into a memorized shape.

The description of the component of FIGS. 9A to 9C may be entirely or partially the same as the description of the components described with reference to FIGS. 1, 2, 3A, 3B, 4A to 4D, 5A to 5C, 6, and 7.

Referring to FIG. 9A, the deformable member 4700 may be disposed inside the acoustic channel 4600. The deformable member 4700 may be deformably disposed inside the acoustic channel 4600. The deformable member 4700 may be deformed inside the acoustic channel 4600 to close at least a portion of the acoustic channel 4600.

According to an embodiment, the acoustic channel 4600 may include an outer peripheral wall 4640. The outer peripheral wall 4640 may form an acoustic path 4670 thereinside. The acoustic path 4670 may mean a space in which sound is transferred. The deformable member 4700 may be disposed in the acoustic path 4670.

According to an embodiment, the outer peripheral wall 4640 may include a first wall 4640a. The outer peripheral wall 4640 may include a second wall 4640b. The first wall 4640a and the second wall 4640b may constitute a portion of the outer peripheral wall 4640. The first wall 4640a and the second wall 4640b may be spaced apart from each other. The first wall 4640a and the second wall 4640b may be disposed to face each other.

According to an embodiment, the deformable member 4700 may include a first deformable member 4710. The deformable member 4700 may include a second deformable member 4720. The first deformable member 4710 and the second deformable member 4720 may be spaced apart from each other. The first deformable member 4710 and the second deformable member 4720 may be disposed inside the acoustic path 4670.

According to an embodiment, the heat-generating source 4800 may include a first heat-generating source 4810. The heat-generating source 4800 may include a second heat-generating source 4820. The first heat-generating source 4810 and the second heat-generating source 4820 may be spaced apart from each other. The first heat-generating source 4810 and the second heat-generating source 4820 may be disposed on the outer surface of the outer peripheral wall 4640. The first heat-generating source 4810 may supply heat to the first deformable member 4710. The first heat-generating source 4810 may be disposed to be capable of heat exchange with the first deformable member 4710. The second heat-generating source 4820 may supply heat to the second deformable member 4720. The second heat-generating source 4820 may be disposed to be capable of heat exchange with the second deformable member 4720.

According to an embodiment, the deformable member 4700 may be deformed inside the acoustic path 4670. The deformable member 4700 may be deformed in response to heat received from the heat-generating source 4800. The heat-generating source 4800 may heat (H) the deformable member 4700 to deform the deformable member 4700. The deformable member 4700 may be deformed by cooling (C). The deformable member 4700 may be deformed by cooling (C) when heat supply from the heat-generating source 4800 is stopped.

According to an embodiment, the first deformable member 4710 may include a first barrier 4711. The first barrier 4711 may be disposed inside the acoustic channel 4600. The first barrier 4711 may be disposed to be capable of heat exchange with the first heat-generating source 4810. The first deformable member 4710 may include a first opening portion 4712. The first opening portion 4712 may be formed to be open in the first barrier 4711.

According to an embodiment, the second deformable member 4720 may include a second barrier 4721. The second barrier 4721 may be disposed inside the acoustic channel 4600. The second barrier 4721 may be disposed to be capable of heat exchange with the second heat-generating source 4820. The second deformable member 4720 may include a second opening portion 4722. The second opening portion 4722 may be formed to be open in the second barrier 4721.

According to an embodiment, the first barrier 4711 may have a cylindrical shape with a hollow. The first barrier 4711 may be disposed to block at least a portion of the acoustic path 4670. The second barrier 4721 may have a cylindrical shape with a hollow. The second barrier 4721 may be disposed to block at least a portion of the acoustic path 4670. The first barrier 4711 and the second barrier 4721 may be spaced apart from each other in the extending direction of the acoustic path 4670. The first barrier 4711 and the second barrier 4721 may face each other in the propagating direction of sound in the acoustic path 4670.

According to an embodiment, the first opening portion 4712 may form an open portion of the first barrier 4711. The first opening portion 4712 may be spaced apart from the outer peripheral wall 4640. The second opening portion 4722 may form an open portion of the second barrier 4721. The second opening portion 4722 may be spaced apart from the outer peripheral wall 4640. The sound in the acoustic path 4670 may be transferred through the first opening portion 4712. The sound in the acoustic path 4670 may be transferred through the second opening portion 4722.

According to an embodiment, when the deformable member 4700 is heated (H), the first opening portion 4712 may face the second barrier 4721 in the extending direction of the acoustic path 4670. The sound transferred along the acoustic path 4670 may hit the second barrier 4721 after passing through the first opening portion 4712.

According to an embodiment, when the deformable member 4700 is heated (H), the second opening portion 4722 may face the first barrier 4711 in the extending direction of the acoustic path 4670. The sound transferred along the acoustic path 4670, may hit the first barrier 4711 before reaching the second opening portion 4722.

According to an embodiment, when the deformable member 4700 is heated (H), the first opening portion 4712 may be formed at a position spaced apart from the center of the first barrier 4711. When the deformable member 4700 is heated (H), the first opening portion 4712 may be formed eccentrically from the first barrier 4711.

According to an embodiment, when the deformable member 4700 is heated (H), the second opening portion 4722 may be formed at a position spaced apart from the center of the second barrier 4721. When the deformable member 4700 is heated (H), the second opening portion 4722 may be formed eccentrically from the second barrier 4721.

According to an embodiment, when the deformable member 4700 is heated (H), the acoustic channel 4600 may have a first area S4. The first area S4 may mean an area in which the second barrier 4721 is positioned in the propagating direction of sound in the acoustic path 4670.

According to an embodiment, when the deformable member 4700 is heated (H), the acoustic channel 4600 may have a second area S5. The second area S5 may mean an area in which the first barrier 4711 and the second barrier 4721 are positioned in the propagating direction of sound in the acoustic path 4670. The second area S5 may be referred to as an “overlapping area.”

According to an embodiment, when the deformable member 4700 is heated (H), the acoustic channel 4600 may have a third area S6. The third area S6 may mean an area in which the first barrier 4711 is positioned in the propagating direction of sound in the acoustic path 4670.

According to an embodiment, the external sound of the housing (e.g., the housing 410 of FIG. 5A to FIG. 5C) may be transferred to the user's ear through the acoustic channel 4600. The sound transferred through the acoustic channel 4600 may include sound in a high frequency area HN and sound in a low frequency area LN. The sound in the high frequency area HN may have a stronger straightness than the sound in the low frequency area LN and, when there is an obstacle on the propagation path, the sound is not transferred. The sound in the low frequency area LN may have stronger diffraction than the sound in the high frequency area HN and, when there is an obstacle on the propagation path, the sound changes its propagation path and propagates.

Due to the deformable member 4700 according to an embodiment of the disclosure, the sound in the high frequency area HN may not be transferred in the acoustic path 4670. For example, the sound in the high frequency area HN in the first area S4 may collide with the second barrier 4721 and may not be transferred. For example, the sound in the high frequency area HN in the second area S5 may collide with the first barrier 4711 and the second barrier 4721 and may not be transferred. For example, the sound in the high frequency area HN in the third area S6 may collide with the first barrier 4711 and may not be transferred.

Referring to FIG. 9B, before the deformable member 4700 is heated (e.g., the H process of FIG. 9A), the barriers 4711 and 4721 and the opening portions 4712 and 4722 may form a concentric circle.

According to an embodiment, an electronic device (e.g., 300 of FIG. 3A) may include a housing 410, a battery 421, a speaker 440, and a protrusion 416. The description of the components 410, 421, 440, and 416 may be the same as the description of the components described with reference to FIGS. 1, 2, 3A, 3B, 4A to 4D, and 5A to 5C, 6, and 7.

According to an embodiment, the electronic device (e.g., 300 of FIG. 3A) may include a battery supporter 422. The battery supporter 422 may provide a space in which the battery 421 is disposed. The battery supporter 422 may be spaced apart from the inner surface of the housing 410.

According to an embodiment, the acoustic channel 4600 may be formed between the inner surface 410a of the housing 410 and the outer surface 422a of the battery supporter 422. The deformable member 4700 may be disposed between the inner surface 410a of the housing 410 and the outer surface 422a of the battery supporter 422. The sound introduced into the housing 410 through the inlet hole 4610 may be transferred to the protrusion 416 through the acoustic channel 4600.

According to an embodiment, the acoustic path 4670 may be formed between the housing 410 and the battery supporter 422. The outer surface 422a of the battery supporter 422 may form a first wall 4640a of the acoustic channel 4600. The inner surface 410a of the housing 410 may form a second wall 4640b of the acoustic channel 4600.

According to an embodiment, the first heat-generating source 4810 and the second heat-generating source 4820 may not heat the deformable members 4710 and 4720. The first opening portion 4712 and the second opening portion 4722 may face each other in the propagating direction of sound. The deformable members 4710 and 4720 may not interfere with the sound transferred in the acoustic path 4670.

Referring to FIG. 9C, after the deformable member 4700 is heated (e.g., the H process of FIG. 9A), the opening portions 4712 and 4722 may be formed eccentrically from the barriers 4711 and 4721.

According to an embodiment, the first heat-generating source 4810 and the second heat-generating source 4820 may heat (H) the deformable members 4710 and 4720. The first opening portion 4712 may be formed offset on the outer surface 422a of the battery supporter 422. The first opening portion 4712 may be positioned further adjacent to the battery supporter 422 than the housing 410. The first opening portion 4712 may face the second barrier 4721 in the direction in which sound is transferred. The second opening portion 4722 may be formed offset on the inner surface 410a of the housing 410. The second opening portion 4722 may be positioned further adjacent to the housing 410 than the battery supporter 422. The second opening portion 4722 may face the first barrier 4711 in the direction in which sound is transferred. The sound transferred into the acoustic path 4670, may interfere with the first barrier 4711 or the second barrier 4721.

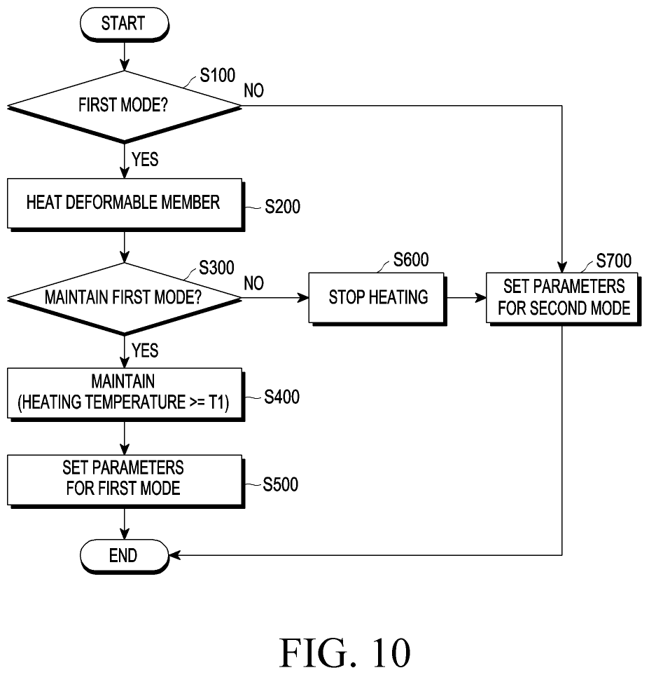

FIG. 10 is a block diagram illustrating a process of operating an electronic device (e.g., 300 of FIG. 3A) according to an embodiment of the disclosure.

The components described with reference to FIG. 10 may be entirely or partially the same as the components described with reference to FIGS. 1, 2, 3A, 3B, 4A to 4D, 5A to 5C, 6, 7, 8A to 8C, and 9A to 9C.

According to an embodiment, the electronic device (e.g., 300 of FIG. 3A) may include a controller (e.g., 490 of FIG. 6) that communicates with the outside of the electronic device (e.g., touch or voice) and receives a command signal (e.g., touch or voice).

According to an embodiment, the controller 490 may determine whether to be driven in a first mode at operation S100. The controller 490 may determine whether to be driven in the first mode when receiving a communication signal from the outside of the electronic device (e.g., 300 of FIG. 3A) or when a physical signal is applied to the electronic device (e.g., 300 of FIG. 3A) at operation S100. The first mode may be a mode for blocking the external sound of the housing (e.g., 410 of FIGS. 5A to 5C). The first mode may be referred to as an “active noise cancel mode.” The first mode may be referred to as an ANC mode.

According to an embodiment, when the electronic device (e.g., 300 of FIG. 3A) is driven in the first mode, the deformable member (e.g., 470 of FIG. 6) may be heated at operation S200. The controller 490 may be electrically connected to a heat-generating source (e.g., 480 of FIG. 6). When the electronic device (e.g., 300 of FIG. 3A) is driven in the first mode, the controller 490 may control the heat-generating source (e.g., 480 of FIG. 6) to supply heat to the deformable member (e.g., 470 of FIG. 6). The deformable member (e.g., 470 of FIG. 6) may be deformed in response to heat received from the heat-generating source (e.g., 480 of FIG. 6).

According to an embodiment, the controller 490 may determine whether to maintain the electronic device (e.g., 300 of FIG. 3A) in the first mode at operation S300. The controller 490 may stop driving the heat-generating source (e.g., 480 of FIG. 6) when receiving a communication signal for stopping the first mode from the outside of the electronic device (e.g., 300 of FIG. 3A) or when a physical signal for stopping the first mode is applied to the electronic device (e.g., 300 of FIG. 3A). In this case, the deformable member (e.g., 470 of FIG. 6) may be cooled and deformed.

According to an embodiment, the controller 490 may drive the electronic device (e.g., 300 of FIG. 3A) in a second mode. The second mode may be a mode in which the external sound of the housing (e.g., 410 of FIGS. 5A to 5C) is transferred. The second mode may be referred to as an “ambient mode.” The second mode may be referred to as an “ANC Off mode.” When the electronic device (e.g., 300 of FIG. 3A) is not driven in the first mode (e.g., after operation S100 or after operation S600), the controller 490 may set parameters for the second mode at operation S700.

According to an embodiment, the controller 490 may maintain the driving of the heat-generating source (e.g., 480 of FIG. 6) when the electronic device (e.g., 300 of FIG. 3A) maintains the driving in the first mode at operation S400. The controller 490 may control the heat-generating source 480 so that the temperature of the deformable member (e.g., 470 of FIG. 7) is larger than the shape recovery temperature T1 at operation S400. The shape recovery temperature T1 may be in a range of 35 to 55 degrees Celsius. The description of the shape recovery temperature T1 may be the same as the description of the shape recovery temperature described with reference to FIG. 7.

According to an embodiment, the controller 490 may set parameters for the first mode when the electronic device (e.g., 300 of FIG. 3A) is driven in the first mode at operation S500. The parameters may be a frequency band processed by a processor (e.g., 491 of FIG. 6).

The electronic device including the speaker may provide a mode for blocking external sound. The electronic device may place a deformable member in the acoustic path to block external sound, and reduce external noise through deformation of the member.

However, conventional electronic devices failed to block noise in high frequency bands with strong straightness, as they required continuous current application to deform the member and had to keep the acoustic path open at all times.

According to various embodiments of the disclosure, it is possible to reduce noise in high frequency bands with strong straightness.

According to various embodiments of the disclosure, it is possible to decrease energy consumption for deformation of the deformable member.

The disclosure is not limited to the foregoing embodiments but various modifications or changes may rather be made thereto without departing from the spirit and scope of the disclosure.

The electronic device according to various embodiments of the disclosure may reduce energy consumption for noise blocking by using a member that is deformed in response to heat received.

The electronic device according to various embodiments of the disclosure may reduce noise in high frequency bands by forming an overlapping area to block a portion of the acoustic path.

Effects obtainable from the disclosure are not limited to the above-mentioned effects, and other effects not mentioned may be apparent to one of ordinary skill in the art from the following description.

According to an embodiment, an electronic device (e.g., 300 of FIG. 3A) may comprise a housing (e.g., 410) having a hole (e.g., 412, 417, 461) communicating with the outside.

According to an embodiment, the electronic device (e.g., 300 of FIG. 3A) may comprise a speaker (e.g., 440) disposed inside the housing (e.g., 410).

According to an embodiment, the electronic device (e.g., 300 of FIG. 3A) may comprise an acoustic channel (e.g., 450, 460; 450, 560; 650, 660; 4600) formed inside the housing (e.g., 410) and configured to propagate sound that is transmitted through the hole (e.g., 412, 417, 461).

According to an embodiment, the electronic device (e.g., 300 of FIG. 3A) may comprise a heat-generating source (e.g., 480; 4800) configured to generate heat.

According to an embodiment, the electronic device (e.g., 300 of FIG. 3A) may comprise a deformable member (e.g., 470; 570; 670; 4700) disposed inside the acoustic channel (e.g., 450, 460; 450, 560; 650, 660; 4600), and formed to at least partially close the acoustic channel (e.g., 450, 460; 450, 560; 650, 660; 4600) in response to heat received from the heat-generating source (e.g., 480; 4800).

According to an embodiment, the acoustic channel (e.g., 450, 460; 450, 560; 650, 660; 4600) may include an outer peripheral wall (e.g., 464; 4640).

According to an embodiment, the acoustic channel (e.g., 450, 460; 450, 560; 650, 660; 4600) may include an acoustic path (e.g., 467; 4670) formed inside the outer peripheral wall (e.g., 464; 4640) and connected to the hole (e.g., 412, 417, 461).

According to an embodiment, the deformable member (e.g., 470; 570; 670; 4700) may be deformed toward a central portion of the acoustic path (e.g., 467; 4670) from the outer peripheral wall (e.g., 464; 4640).

According to an embodiment, the deformable member (e.g., 470; 570; 670; 4700) may include a first deformable member (e.g., 471; 4710) extending from the outer peripheral wall (e.g., 464; 4640) to the acoustic path (e.g., 467; 4670) in response to heat received from the heat-generating source (e.g., 480; 4800).

According to an embodiment, the deformable member (e.g., 470; 570; 670; 4700) may include a second deformable member (e.g., 472; 4720) that at least partially faces the first deformable member (e.g., 471; 4710) in response to heat received from the heat-generating source (e.g., 480; 4800).

According to an embodiment, the acoustic channel (e.g., 467; 4670) may include an overlapping area (e.g., S2; S5) where the first deformable member (e.g., 471; 4710) and the second deformable member (e.g., 472; 4720) face each other when heat is supplied from the heat-generating source (e.g., 480; 4800) to the deformable member (e.g., 470; 570; 670; 4700).

According to an embodiment, the deformable member (e.g., 470) may be bent toward a central portion of the acoustic path (e.g., 467) in response to heat received from the heat-generating source (e.g., 480).

According to an embodiment, the deformable member (e.g., 470) may include a first deformable member (e.g., 471) including a first support portion (e.g., 471a) disposed on the outer peripheral wall (e.g., 464) and a first bent portion (e.g., 471b) extending toward a central portion of the acoustic path (e.g., 467) from the first support portion (e.g., 471a) in response to heat received from the heat-generating source (e.g., 480).

According to an embodiment, the deformable member (e.g., 470) may include a second deformable member (e.g., 472) including a second support portion (e.g., 472a) disposed on the outer peripheral wall (e.g., 464) and a second bent portion (e.g., 472b) extending toward a central portion of the acoustic path (e.g., 467) from the second support portion (e.g., 472a) in response to heat received from the heat-generating source (e.g., 480).

According to an embodiment, the acoustic channel (e.g., 460) may include an overlapping area (e.g., S2) where the first bent portion (e.g., 471b) and the second bent portion (e.g., 472b) face each other in the extending direction of the acoustic path (e.g., 467).

According to an embodiment, the deformable member (e.g., 4700) may include a barrier (e.g., 4711, 4721) disposed in the acoustic path (e.g., 4670).

According to an embodiment, the deformable member (e.g., 4700) may include an opening portion (e.g., 4712, 4722) formed in the barrier (e.g., 4711, 4721).

According to an embodiment, an open position of the opening portion (e.g., 4712, 4722) formed in the barrier (e.g., 4711, 4721) may change in response to heat received from the heat-generating source (e.g., 4800).

According to an embodiment, the deformable member (e.g., 4700) may include a first deformable member (e.g., 4710) including a first barrier (e.g., 4711) disposed in the acoustic path (e.g., 4670) and a first opening portion (e.g., 4712) formed in the first barrier (e.g., 4711).

According to an embodiment, the deformable member (e.g., 4700) may include a second deformable member (e.g., 4720) including a second barrier (e.g., 4721) disposed in the acoustic path (e.g., 4670) and a second opening portion (e.g., 4722) formed in the second barrier (e.g., 4721).

According to an embodiment, the acoustic channel (e.g., 4600) may include an overlapping area (e.g., S5) in which the first barrier (e.g., 4711) and the second barrier (e.g., 4721) face each other in the extending direction of the acoustic path (e.g., 4670).

According to an embodiment, the electronic device (e.g., 300 of FIG. 3A) may comprise a battery (e.g., 421) disposed inside the housing (e.g., 410).

According to an embodiment, the electronic device (e.g., 300 of FIG. 3A) may comprise a battery supporter (e.g., 422) disposed between the housing (e.g., 410) and the battery (e.g., 421).

According to an embodiment, the acoustic channel (e.g., 460; 4600) may be formed between an inner surface (e.g., 410a) of the housing (e.g., 410) and an outer surface (e.g., 422a) of the battery supporter (e.g., 422).

According to an embodiment, the hole (e.g., 412, 417, 461; 561, 564; 661) may include a first hole (e.g., 412) open to an outside of the housing.

According to an embodiment, the hole (e.g., 412, 417, 461; 561, 564; 661) may include an inlet hole (e.g., 461) open to the outside of the housing at a position separate from the first hole.

According to an embodiment, the acoustic channel (e.g., 450, 460; 450, 560; 650, 660; 4600) may include a first acoustic channel (e.g., 450; 650) extending from the first hole (e.g., 412).

According to an embodiment, the acoustic channel (e.g., 450, 460; 450, 560; 650, 660; 4600) may include a second acoustic channel (e.g., 460; 560; 660) including the inlet hole (e.g., 461; 561, 564; 661).

According to an embodiment, the deformable member (e.g., 470; 570; 670) may be disposed in the inlet hole (e.g., 461; 561, 564; 661).

According to an embodiment, the inlet hole (e.g., 561, 564) may include a first inlet hole (e.g., 561).

According to an embodiment, the inlet hole (e.g., 561, 564) may include a second inlet hole (e.g., 564) spaced apart from the first inlet hole (e.g., 561).

According to an embodiment, the second acoustic channel (e.g., 560) may include a first acoustic path (e.g., 563) extending from the first inlet hole (e.g., 561).

According to an embodiment, the second acoustic channel (e.g., 560) may include a second acoustic path (e.g., 565) extending from the second inlet hole (e.g., 564).

According to an embodiment, the second acoustic channel (e.g., 560) may include a path merging portion (e.g., 566) connecting the first acoustic path (e.g., 563) and the second acoustic path (e.g., 565).

According to an embodiment, the second acoustic channel (e.g., 660) may merge into the first acoustic channel (e.g., 650).

According to an embodiment, the electronic device (e.g., 300 of FIG. 3A) may comprise a controller (e.g., 490) electrically connected to the heat-generating source (e.g., 480; 4800).

According to an embodiment, the controller (e.g., 490) may drive the heat-generating source (e.g., 480; 4800) to supply heat to the deformable member (e.g., 470; 4700) when the electronic device (e.g., 300) is operated in a first mode for blocking external sound of the housing (e.g., 410).

According to an embodiment, the deformable member (e.g., 470; 4700) may be a shape memory alloy.

According to an embodiment, the deformable member (e.g., 470; 4700) may be deformed into a first shape at a temperature equal to or higher than a predetermined shape recovery temperature (e.g., T1), and may be deformed into a second shape different from the first shape at a temperature lower than the predetermined shape recovery temperature (e.g., T1).

According to an embodiment, an electronic device (e.g., 300 of FIG. 3A) comprises a housing (e.g., 410) having a hole (e.g., 412, 417, 461) that is open to the outside, a speaker (e.g., 440) disposed inside the housing (e.g., 410), an acoustic channel (e.g., 450, 460; 450, 560; 650, 660; 4600) formed inside the housing (e.g., 410) and formed so that sound transmitted through the hole (e.g., 412, 417, 461) is transferred therethrough, a first deformable member (e.g., 471; 4710) disposed inside the acoustic channel (e.g., 450, 460; 450, 560; 650, 660; 4600), and a second deformable member (e.g., 472; 4720) disposed inside the acoustic channel (e.g., 450, 460; 450, 560; 650, 660; 4600) and spaced apart from the first deformable member (e.g., 471; 4710) in the extending direction of the acoustic channel (e.g., 450, 460; 450, 560; 650, 660; 4600). The acoustic channel (e.g., 450, 460; 450, 560; 650, 660; 4600) includes an overlapping area (e.g., S2; S5) in which the first deformable member (e.g., 471; 4710) and the second deformable member (e.g., 472:4720) face each other when the first deformable member (e.g., 471; 4710) and the second deformable member (e.g., 472:4720) are deformed.

According to an embodiment, the electronic device (e.g., 300 of FIG. 3A) may comprise a heat-generating source (e.g., 480; 4800) supplying heat to the first deformable member (e.g., 471; 4710) and the second deformable member (e.g., 472; 4720).

According to an embodiment, the first deformable member (e.g., 471; 4710) and the second deformable member (e.g., 472; 4720) may be deformed in response to heat received from the heat-generating source (e.g., 480; 4800).

According to an embodiment, the first deformable member (e.g., 471) may include a first support portion (e.g., 471a) disposed on an outer peripheral wall (e.g., 464) of the acoustic channel (e.g., 460).

According to an embodiment, the first deformable member (e.g., 471) may further include a first bent portion (e.g., 471b) extending from the first support portion (e.g., 471a) toward a central portion of the acoustic channel (e.g., 460).

According to an embodiment, the second deformable member (e.g., 472) may include a second support portion (e.g., 472a) disposed on the outer peripheral wall (e.g., 464) of the acoustic channel (e.g., 460).

According to an embodiment, the second deformable member (e.g., 472) may further include a second bent portion (e.g., 472b) extending from the second support portion (e.g., 472a) toward a central portion of the acoustic channel (e.g., 460).

According to an embodiment, the overlapping area (e.g., S2) may be an area where the first bent portion (e.g., 471b) and the second bent portion (e.g., 472b) are positioned in the extending direction of the acoustic channel (e.g., 460).

According to an embodiment, the first deformable member (e.g., 4710) may include a first barrier (e.g., 4711) disposed inside the acoustic channel (e.g., 4600).

According to an embodiment, the first deformable member (e.g., 4710) may further include a first opening portion (e.g., 4712) formed in the first barrier (e.g., 4711).

According to an embodiment, the second deformable member (e.g., 4720) may include a second barrier (e.g., 4721) disposed inside the acoustic channel (e.g., 4600) and spaced apart from the first barrier (e.g., 4711).

According to an embodiment, the second deformable member (e.g., 4720) may further include a second opening portion (e.g., 4722) formed in the second barrier (e.g., 4721).

According to an embodiment, the overlapping area (e.g., S5) may be an area where the first barrier (e.g., 4711) and the second barrier (e.g., 4721) are positioned in the extending direction of the acoustic channel (e.g., 4600).

According to an embodiment, the first deformable member (e.g., 471; 4710) and the second deformable member (e.g., 472; 4720) may be a shape memory alloy.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a housing having a hole communicating with the outside;
a speaker disposed inside the housing;
an acoustic channel formed inside the housing and configured to propagate sound that is transmitted through the hole;
a heat-generating source configured to generate heat; and
a deformable member disposed inside the acoustic channel, and formed to at least partially close the acoustic channel in response to heat received from the heat-generating source.

2. The electronic device of claim 1,
wherein the acoustic channel includes:
an outer peripheral wall, and
an acoustic path formed inside the outer peripheral wall and extending in a direction in which the sound transmitted through the hole propagates, and
wherein the deformable member is deformed in a direction intersecting the extending direction of the acoustic path from the outer peripheral wall.

3. The electronic device of claim 2,
wherein the outer peripheral wall includes:
a first wall, and
a second wall spaced apart from the first wall and forming the acoustic path between the first wall and the second wall,
wherein the deformable member includes:
a first deformable member that is deformed in a direction intersecting the extending direction of the acoustic path from the first wall in response to heat received from the heat-generating source, and
a second deformable member that is deformed in a direction intersecting the extending direction of the acoustic path from the second wall in response to heat received from the heat-generating source, the second deformable member at least partially facing the first deformable member, and
wherein the acoustic channel includes an overlapping area where the first deformable member and the second deformable member face each other when heat is supplied from the heat-generating source to the deformable member.

4. The electronic device of claim 2, wherein the deformable member is bent in a direction intersecting the extending direction of the acoustic path in response to heat received from the heat-generating source.

5. The electronic device of claim 2,
wherein the deformable member includes:
a first deformable member including a first support portion disposed on the outer peripheral wall and a first bent portion extending toward a central portion of the acoustic path from the first support portion in response to heat received from the heat-generating source, and
a second deformable member including a second support portion disposed on the outer peripheral wall and a second bent portion extending toward the central portion of the acoustic path from the second support portion in response to heat received from the heat-generating source, and
wherein the acoustic channel includes an overlapping area in which the first bent portion and the second bent portion at least partially face each other in the extending direction of the acoustic path.

6. The electronic device of claim 2,
wherein the deformable member includes:
a barrier disposed in the acoustic path, and
an opening portion formed in the barrier, and
wherein a position of the opening portion formed in the barrier changes in response to heat received from the heat-generating source.

7. The electronic device of claim 2,
wherein the deformable member includes:
a first deformable member including a first barrier disposed in the acoustic path and a first opening portion formed in the first barrier, and
a second deformable member including a second barrier disposed in the acoustic path and a second opening portion formed in the second barrier, and
wherein the acoustic channel includes an overlapping area in which the first barrier and the second barrier at least partially face each other in the extending direction of the acoustic path in response to heat received from the heat-generating source.

8. The electronic device of claim 1, further comprising:
a battery disposed inside the housing; and
a battery supporter disposed between the housing and the battery,
wherein the acoustic channel is formed between an inner surface of the housing and an outer surface of the battery supporter.

9. The electronic device of claim 1,
wherein the hole includes:
a first hole open to an outside of the housing, and
an inlet hole open to the outside of the housing at a position separate from the first hole, and
wherein the acoustic channel includes:
a first acoustic channel extending from the first hole; and
a second acoustic channel including the inlet hole.

10. The electronic device of claim 9, wherein the deformable member is disposed in the inlet hole.

11. The electronic device of claim 9,
wherein the inlet hole includes:
a first inlet hole, and
a second inlet hole spaced apart from the first inlet hole, and
wherein the second acoustic channel includes:
a first acoustic path extending from the first inlet hole,
a second acoustic path extending from the second inlet hole, and
a path merging portion connecting the first acoustic path and the second acoustic path.

12. The electronic device of claim 9, wherein the second acoustic channel merges into the first acoustic channel.

13. The electronic device of claim 1, further comprising:
a controller electrically connected to the heat-generating source,
wherein the controller drives the heat-generating source to supply heat to the deformable member when the electronic device is driven in a first mode for blocking external sound of the housing.

14. The electronic device of claim 1, wherein the deformable member is a shape memory alloy.

15. The electronic device of claim 1,
wherein the deformable member is deformed into a first shape at a temperature equal to or higher than a predetermined shape recovery temperature, and
wherein the deformable member is deformed into a second shape different from the first shape at a temperature lower than the predetermined shape recovery temperature.

16. An electronic device, comprising:
a housing having a hole communicating with the outside;
a speaker disposed inside the housing;
an acoustic channel formed inside the housing and configured to propagate sound transmitted through the hole;
a first deformable member disposed inside the acoustic channel; and
a second deformable member disposed inside the acoustic channel and spaced apart from the first deformable member in an extending direction of the acoustic channel,
wherein the acoustic channel includes an overlapping area in which at least a portion of the first deformable member and the second deformable member face each other when the first deformable member and the second deformable member are deformed.

17. The electronic device of claim 16, further comprising:
a heat-generating source configured to supply heat to the first deformable member and the second deformable member,
wherein the first deformable member and the second deformable member are deformed in response to heat received from the heat-generating source.

18. The electronic device of claim 16,
wherein the first deformable member includes:
a first support portion disposed on an outer peripheral wall of the acoustic channel, and
a first bent portion extending toward a central portion of the acoustic channel from the first support portion in response to heat received,
wherein the second deformable member includes:
a second support portion disposed on the outer peripheral wall of the acoustic channel, and
a second bent portion extending toward the central portion of the acoustic channel from the second support portion in response to heat received, and
wherein the overlapping area is an area in which the first bent portion and the second bent portion are positioned in the extending direction of the acoustic channel.

19. The electronic device of claim 16,
wherein the first deformable member includes:
a first barrier disposed inside the acoustic channel, and
a first opening portion formed in the first barrier,
wherein the second deformable member includes:
a second barrier disposed inside the acoustic channel and spaced apart from the first barrier, and
a second opening portion formed in the second barrier, and
wherein the overlapping area is an area in which the first barrier and the second barrier are positioned in the extending direction of the acoustic channel.

20. The electronic device of claim 16,
wherein the first deformable member and the second deformable member are a shape memory alloy.
